(19) United States
(12) Patent Application Publication
(10) Pub. No.: US 2022/0355522 A1
(43) Pub. Date: Nov. 10, 2022

(54) INJECTION MOLDING MACHINE, INJECTION MOLDING MACHINE SYSTEM, AND MONITORING DEVICE

(71) Applicant: SUMITOMO HEAVY INDUSTRIES, LTD., Tokyo (JP)

(72) Inventors: Mikio Arita, Kanagawa (JP); Hiroshi Mogi, Kanagawa (JP)

(21) Appl. No.: 17/873,868

(22) Filed: Jul. 26, 2022

Related U.S. Application Data
(63) Continuation of application No. PCT/JP2021/005904, filed on Feb. 17, 2021.

(30) Foreign Application Priority Data
Mar. 3, 2020 (JP) 2020-036151

(51) Int. Cl. B29C 45/84

(52) U.S. Cl. CPC B29C 45/84; B29C 2945/76163

(57) ABSTRACT

An injection molding machine management system SYS according to an embodiment includes an injection molding machine and a management device provided outside the injection molding machine and that monitors an abnormality in the injection molding machine, in which in a case where an abnormality occurs in the injection molding machine, the management device automatically reboots the injection molding machine in a safe mode having a more limited function than a normal boot mode. In addition, an injection molding machine according to another embodiment includes a CPU and an FPGA that monitors an abnormality in a predetermined software executed by the CPU, in which in a case where an abnormality occurs in a system software executed by the CPU, the FPGA automatically reboots the system software of the CPU in a safe mode having a more limited function than the normal boot mode.

### RELATED APPLICATIONS

The contents of Japanese Patent Application No. 2020-036151, and of International Patent Application No. PCT/JP2021/005904, on the basis of each of which priority benefits are claimed in an accompanying application data sheet, are in their entirety incorporated herein by reference.

### BACKGROUND

### Technical Field

Certain embodiment of the present invention relates to an injection molding machine and the like.

### Description of Related Art

For example, a technique is disclosed in which an injection molding machine is booted in a limited boot mode in which a function is restricted compared to a normal boot mode at the time of next booting, in a case where the injection molding machine is stopped in an abnormal state (refer to the related art).

### SUMMARY

According to an embodiment of the present disclosure, there is provided an injection molding machine including an information processing unit, and a monitoring unit provided separately from the information processing unit and that monitors an abnormality in the information processing unit, in which in a case where an abnormality occurs in the information processing unit, the monitoring unit automatically reboots the information processing unit in a predetermined boot mode having a more limited function than a normal boot mode.

In addition, according to another embodiment of the present disclosure, there is provided an injection molding machine system including an injection molding machine, and a monitoring device provided outside the injection molding machine and that monitors an abnormality in the injection molding machine, in which in a case where an abnormality occurs in the injection molding machine, the monitoring device automatically reboots the injection molding machine in a predetermined boot mode having a more limited function than a normal boot mode.

In addition, according to still another embodiment of the present disclosure, there is provided a monitoring device that is communicably connected to an injection molding machine and automatically reboots the injection molding machine in a predetermined boot mode having a more limited function than a normal boot mode in a case where an abnormality occurs in the injection molding machine.

### BRIEF DESCRIPTION OF THE DRAWINGS

FIG. 1 is a diagram illustrating an example of a configuration of an injection molding machine management system including an injection molding machine.

FIG. 2 is a diagram illustrating an example of a configuration of the injection molding machine management system including the injection molding machine.

FIG. 3 is a diagram illustrating a first example of a detailed configuration of a control device.

FIG. 4 is a flowchart schematically illustrating a first example of control processing relating to abnormality monitoring by the control device.

FIG. 5 is a diagram illustrating a second example of the detailed configuration of the control device.

FIG. 6 is a flowchart schematically illustrating a second example of control processing relating to abnormality monitoring by the control device.

FIG. 7 is a diagram illustrating a third example of the detailed configuration of the control device.

FIG. 8 is a flowchart schematically illustrating a third example of control processing relating to abnormality monitoring by the control device.

### DETAILED DESCRIPTION

However, in the case of the above technique, after an abnormality occurs in the injection molding machine and the injection molding machine is stopped, it is necessary for the user to go to the injection molding machine and perform an operation to boot the injection molding machine, or to perform a remote control to boot the injection molding machine through an external device capable of remotely controlling the injection molding machine. Therefore, it is desirable that the injection molding machine can be automatically restored in a case where an abnormality occurs in the injection molding machine.

Therefore, it is desirable to provide a technique capable of automatically restoring an injection molding machine in a case where an abnormality occurs in the injection molding machine.

Hereinafter, embodiments will be described with reference to the drawings.

### Configuration of Injection Molding Machine Management System

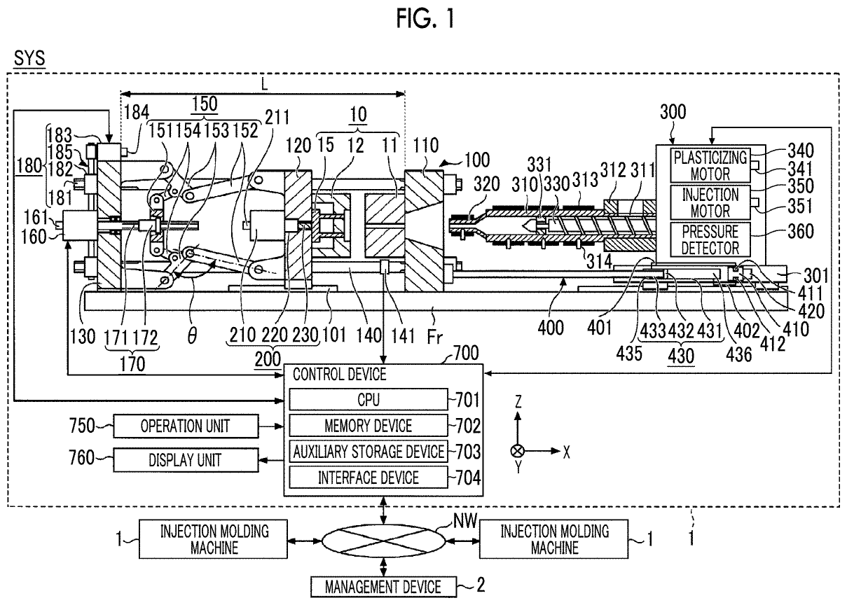

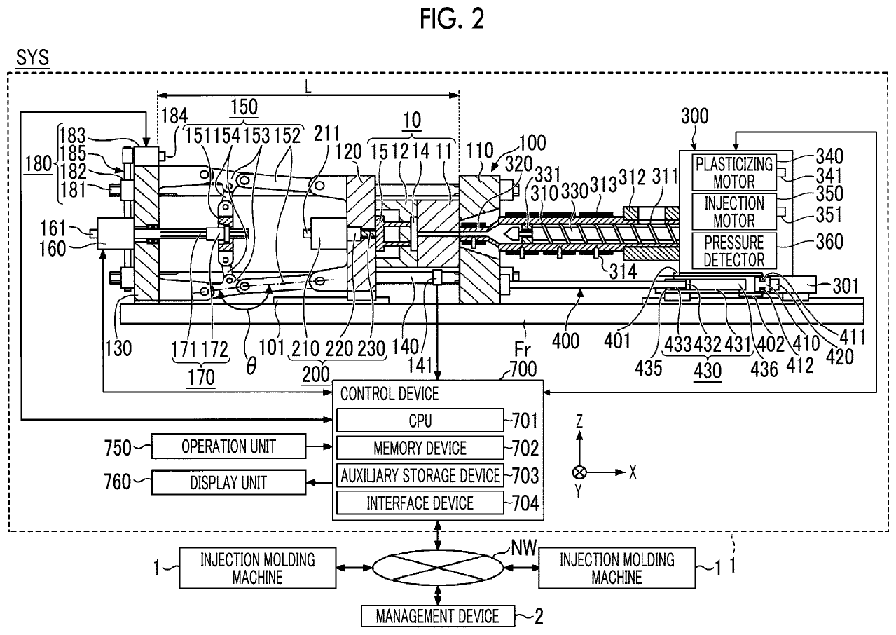

First, with reference to FIGS. 1 and 2, a configuration of an injection molding machine management system (hereinafter, simply “management system”) SYS (an example of an injection molding machine system) according to the present embodiment will be described.

FIGS. 1 and 2 are diagrams illustrating an example of the management system SYS according to the present embodiment. Specifically, in FIG. 1, a side sectional view illustrating a state when a mold opening of an injection molding machine 1 is completed is drawn. In FIG. 2, a side sectional view illustrating a state of the injection molding machine 1 at the time of mold clamping is drawn. Hereinafter, in the drawings of the present embodiment, an X-axis, a Y-axis, and a Z-axis are perpendicular to each other. Positive and negative directions of the X-axis (hereinafter, simply “X-direction”) and positive and negative directions of the Y-axis (hereinafter, simply “Y-direction”) represent a horizontal direction, and positive and negative directions of the Z-axis (hereinafter, simply “Z-direction”) represent a vertical direction.

The management system SYS includes a plurality (three in the present example) of injection molding machines 1 and a management device 2.

The management system SYS manages (monitors) a state and an operating status of the injection molding machine 1 in the management device 2.

In the management system SYS, the management device 2 and the injection molding machine 1 may be operated by the same person as a whole. In this case, the management device 2 and the injection molding machine 1 may be operated together by, for example, a person (company) who owns a factory in which the injection molding machine 1 is installed. In addition, for example, in the management system SYS, the management device 2 and the injection molding machine 1 may be operated by different persons. In this case, for example, the management device 2 may be operated by a manufacturer of the injection molding machine 1 that delivers the injection molding machine 1 to the factory. That is, the manufacturer of the injection molding machine 1 may provide a customer (factory owner) with a management service of the injection molding machine 1 through the management device 2 as well as the injection molding machine 1. In addition, for example, the management device 2 may be operated by a third party (consignment company) who is entrusted with the management of the injection molding machine 1 by the owner (company) of the factory where the injection molding machine 1 is installed. That is, the management service of the injection molding machine 1 through the management device 2 may be provided to the owner of the factory by a consignment company different from the manufacturer of the injection molding machine 1.

The number of injection molding machines 1 included in the management system SYS may be one, two, or four or more. In addition, the number of management devices 2 included in the management system SYS may be plural. In this case, for example, each of a plurality of management devices 2 may manage a part of the injection molding machines 1 among all the injection molding machines 1 included in the management system SYS.

### Configuration of Injection Molding Machine

The injection molding machine 1 performs a series of operations for obtaining a molding product.

In addition, the injection molding machine 1 is communicably connected to the management device 2 through a predetermined communication line NW. In addition, the injection molding machine 1 may be communicably connected to the other injection molding machine 1 through the communication line NW. For example, the communication line NW includes a local network (local area network: LAN) inside a factory where the injection molding machine 1 is installed. The local network may be wired, wireless, or a mode including both. In addition, for example, the communication line NW may include a wide area network (WAN) outside a factory where the injection molding machine 1 is installed. For example, the wide area network may include a mobile communication network having a base station as a terminal. For example, the mobile communication network may support 4^{th} generation (4G) or 5^{th} generation (5G) including long term evolution (LTE). In addition, the wide area network may include, for example, a satellite communication network that uses a communication satellite. In addition, the wide area network may include, for example, an Internet network. In addition, the communication line NW may include, for example, a short-range wireless communication line corresponding to Bluetooth (registered trademark) communication or WiFi communication.

In addition, the injection molding machine 1 transmits (uploads) data relating to the operation state of the injection molding machine 1 (hereinafter, “operation state data”) to the management device 2 through the communication line NW. In this manner, the management device 2 (or a manager or a worker thereof) can identify the operation state, and can manage a maintenance time of the injection molding machine 1 or an operation schedule of the injection molding machine 1. In addition, the management device 2 can control the injection molding machine 1 from the outside by generating data relating to the control of the injection molding machine 1 (for example, molding conditions) based on operation state data of the injection molding machine 1, and transmitting the data to the injection molding machine 1.

In addition, for example, the injection molding machine 1 as a master machine may monitor or control an operation of the other injection molding machine 1 as a slave machine through the communication line NW. Specifically, the injection molding machine 1 (slave machine) may transmit operation state data to the injection molding machine 1 (master machine) through the communication line NW. In this manner, the injection molding machine 1 (master machine) can monitor the operation of the other injection molding machine 1 (slave machine). In addition, the injection molding machine 1 (master machine) may transmit a control command relating to the operation to the other injection molding machine 1 (slave machine) through the communication line NW while identifying the operation state of the other injection molding machine 1 (slave machine) based on the operation state data. In this manner, the injection molding machine 1 (master machine) can control the operation of the other injection molding machine 1 (slave machine). The number of master machines included in the management system SYS may be one or plural. In addition, the number of slave machines corresponding to one master machine may be one or plural.

In addition, a version is defined for each of the plurality of injection molding machines 1. Similarly, a version may be defined for a part or all of the equipment constituting the injection molding machine 1 (for example, control device 700 described later), and the version of the injection molding machine 1 may be determined by each version of the constituent equipment. The version is represented by, for example, a numerical value with “1.0” as the initial state, and the numerical value increases when at least one of the hardware and software of the injection molding machine 1 is revised. For example, in a case of a relatively small revision, the fractional portion of the version number increases, and in a case of a relatively large revision, the version number is carried up to the next integer value (for example, “4.0” in a case of the current version is “3.43”). The revision of the injection molding machine 1 includes, for example, addition of functions and changes in specifications of the injection molding machine 1.

The injection molding machine 1 includes a mold clamping unit 100, an ejector unit 200, an injection unit 300, a moving unit 400, and a control device 700.

### Mold Clamping Unit

The mold clamping unit 100 performs mold closing, mold clamping, and mold opening of the mold unit 10. For example, the mold clamping unit 100 is a horizontal type, and a mold opening and closing direction is a horizontal direction. The mold clamping unit 100 has a stationary platen 110, a movable platen 120, a toggle support 130, a tie bar 140, a toggle mechanism 150, a mold clamping motor 160, a motion conversion mechanism 170, and a mold space adjustment mechanism 180.

Hereinafter, in describing the mold clamping unit 100, a moving direction of the movable platen 120 during mold closing (rightward direction in FIG. 1) will be defined as forward, and a moving direction of the movable platen 120 during mold opening (leftward direction in FIG. 1) will be defined as rearward.

The stationary platen 110 is fixed to a frame Fr. A stationary mold 11 is attached to a surface of the stationary platen 110 which faces the movable platen 120.

The movable platen 120 is movable with respect to the frame Fr in the mold opening and closing direction. A guide 101 that guides the movable platen 120 is laid on the frame Fr. The movable mold 12 is attached to a surface of the movable platen 120 which faces the stationary platen 110.

Since the movable platen 120 is advanced and retreated with respect to the stationary platen 110, the mold closing, the mold clamping, and the mold opening are performed.

The mold unit 10 includes the stationary mold 11 corresponding to the stationary platen 110 and a movable mold 12 corresponding to the movable platen 120.

The toggle support 130 is connected to the stationary platen 110 at a predetermined interval L, and is mounted on the frame Fr to be movable in the mold opening and closing direction. For example, the toggle support 130 may be movable along a guide laid on the frame Fr. In this case, a guide of the toggle support 130 may be common to the guide 101 of the movable platen 120.

The stationary platen 110 is fixed to the frame Fr, and the toggle support 130 is movable with respect to the frame Fr in the mold opening and closing direction. However, the toggle support 130 may be fixed to the frame Fr, and the stationary platen 110 may be movable with respect to the frame Fr in the mold opening and closing direction.

The tie bar 140 connects the stationary platen 110 and the toggle support 130 to each other at an interval L in the mold opening and closing direction. A plurality of (for example, four) tie bars 140 may be used. Each of the tie bars 140 is disposed parallel to the mold opening and closing direction, and extends depending on a mold clamping force. At least one of the tie bars 140 is provided with a tie bar strain detector 141 that detects a strain of the tie bar 140. The tie bar strain detector 141 is, for example, a strain gauge. The tie bar strain detector 141 transmits a signal indicating a detection result thereof to the control device 700. The detection result of the tie bar strain detector 141 is used, for example, for detecting the mold clamping force.

Instead of or in addition to the tie bar strain detector 141, any mold clamping force detector that can be used to detect the mold clamping force may be used. For example, the mold clamping force detector is not limited to a strain gauge type, and may be a piezoelectric type, a capacitive type, a hydraulic type, or an electromagnetic type. An attachment position thereof is not limited to the tie bar 140.

The toggle mechanism 150 is disposed between the movable platen 120 and the toggle support 130, and moves the movable platen 120 with respect to the toggle support 130 in the mold opening and closing direction. The toggle mechanism 150 is configured to include a crosshead 151 and a pair of link groups. Each of the link groups has a first link 152 and a second link 153 which are flexibly connected by a pin. The first link 152 is oscillatingly attached to the movable platen 120 by a pin, and the second link 153 is oscillatingly attached to the toggle support 130 by a pin. The second link 153 is attached to the crosshead 151 via a third link 154. When the crosshead 151 is advanced and retreated with respect to the toggle support 130, the first link 152 and the second link 153 are bent and stretched so that the movable platen 120 is advanced and retreated with respect to the toggle support 130.

A configuration of the toggle mechanism 150 is not limited to a configuration illustrated in FIG. 1. For example, in FIG. 1, the number of nodes in each of the link groups is five, but may be four. One end portion of the third link 154 may be coupled to the node between the first link 152 and the second link 153.

The mold clamping motor 160 is attached to the toggle support 130, and operates the toggle mechanism 150. The mold clamping motor 160 advances and retreats the crosshead 151 with respect to the toggle support 130. In this manner, the first link 152 and second link 153 are bent and stretched so that the movable platen 120 is advanced and retreated with respect to the toggle support 130. The mold clamping motor 160 is directly connected to the motion conversion mechanism 170, but may be connected to the motion conversion mechanism 170 via a belt or a pulley.

The motion conversion mechanism 170 converts a rotary motion of the mold clamping motor 160 into a linear motion of the crosshead 151. The motion conversion mechanism 170 includes a screw shaft 171 and a screw nut 172 screwed to the screw shaft 171. A ball or a roller may be interposed between the screw shaft 171 and the screw nut 172.

The mold clamping unit 100 performs a mold closing process, a mold clamping process, and a mold opening process under the control of the control device 700.

In the mold closing process, the mold clamping motor 160 is driven to advance the movable platen 120 by advancing the crosshead 151 to a mold closing completion position at a set speed. In this manner, the movable mold 12 is caused to touch the stationary mold 11. For example, a position or a speed of the crosshead 151 is detected by using a mold clamping motor encoder 161. The mold clamping motor encoder 161 detects rotation of the mold clamping motor 160, and transmits a signal indicating a detection result thereof to the control device 700.

A crosshead position detector for detecting the position of the crosshead 151 and a crosshead speed detector for measuring the speed of the crosshead 151 are not limited to the mold clamping motor encoder 161, and a general detector can be used. In addition, a movable platen position detector for detecting the position of the movable platen 120 and a movable platen speed detector for measuring the speed of the movable platen 120 are not limited to the mold clamping motor encoder 161, and a general detector can be used.

In the mold clamping process, the mold clamping motor 160 is further driven to further advance the crosshead 151 from the mold closing completion position to a mold clamping position, thereby generating a mold clamping force. During the mold clamping, a cavity space 14 is formed between the movable mold 12 and the stationary mold 11, and the injection unit 300 fills the cavity space 14 with a liquid molding material. A molding product is obtained by solidifying the molding material filled therein. The number of the cavity spaces 14 may be two or more. In this case, a plurality of the molding products can be obtained at the same time.

In the mold opening process, the mold clamping motor 160 is driven to retreat the movable platen 120 by retreating the crosshead 151 to the mold opening completion position at a set speed, so that the movable mold 12 is separated from the stationary mold 11. Thereafter, the ejector unit 200 ejects the molding product from the movable mold 12.

Setting conditions in the mold closing process and the mold clamping process are collectively set as a series of setting conditions. For example, the speed or the position of the crosshead 151 (including a mold closing start position, a speed switching position, a mold closing completion position, and a mold clamping position) and the mold clamping force in the mold closing process and the mold clamping process are collectively set as a series of setting conditions. The mold closing start position, the speed switching position, the mold closing completion position, and the mold clamping position are aligned in this order from a rear side toward a front side, and represent a start point and an end point of a section in which the speed is set. The speed is set for each section. The number of the speed switching positions may be one or more. The speed switching position may not be set. Only one of the mold clamping position and the mold clamping force may be set.

In addition, the setting conditions in the mold opening process are set in the same manner. For example, the speed or the position (including the mold opening start position, the speed switching position, and the mold opening completion position) of the crosshead 151 in the mold opening process are collectively set as a series of setting conditions. The mold opening start position, the speed switching position, and the mold opening completion position are aligned in this order from the front side toward the rear side, and represent the start point and the end point of the section in which the speed is set. The speed is set for each section. The number of the speed switching positions may be one or more. The speed switching position may not be set. The mold opening start position and the mold clamping position may be the same position. In addition, the mold opening completion position and the mold closing start position may be the same position.

Instead of the speed or the position of the crosshead 151, the speed or the position of the movable platen 120 may be set. In addition, instead of the position (for example, the mold clamping position) of the crosshead or the position of the movable platen, the mold clamping force may be set.

The toggle mechanism 150 amplifies a driving force of the mold clamping motor 160, and transmits the driving force to the movable platen 120. An amplification magnification is referred to as a toggle magnification. The toggle magnification is changed depending on an angle θ (hereinafter, “link angle θ”) formed by the first link 152 and the second link 153. The link angle θ is obtained from the position of the crosshead 151. When the link angle θ is 180°, the toggle magnification is maximized.

In a case where a thickness of the mold unit 10 is changed due to replacement of the mold unit 10 or a temperature change in the mold unit 10, a mold space is adjusted so that a predetermined mold clamping force is obtained during the mold clamping. For example, in the mold space adjustment, an interval L between the stationary platen 110 and the toggle support 130 is adjusted so that the link angle θ of the toggle mechanism 150 becomes a predetermined angle at the time of mold touch when the movable mold 12 touches the stationary mold 11.

The mold clamping unit 100 has the mold space adjustment mechanism 180 that adjusts a mold space by adjusting the interval L between the stationary platen 110 and the toggle support 130. The mold space adjustment mechanism 180 has a screw shaft 181 formed in a rear end portion of the tie bar 140, a screw nut 182 held to be rotatable by the toggle support 130, and a mold space adjustment motor 183 that rotates the screw nut 182 screwed to the screw shaft 181.

The screw shaft 181 and the screw nut 182 are provided for each of the tie bars 140. The rotation of the mold space adjustment motor 183 may be transmitted to a plurality of the screw nuts 182 via a rotation transmission part 185. The plurality of screw nuts 182 can be rotated in synchronization with each other.

The plurality of screw nuts 182 can be individually rotated by changing a transmission channel of the rotation transmission part 185.

For example, the rotation transmission part 185 is configured to include a gear. In this case, a driven gear is formed on an outer periphery of each of the screw nuts 182, and a driving gear is attached to an output shaft of the mold space adjustment motor 183. A plurality of the driven gears and an intermediate gear meshing with the driving gear are held to be rotatable in a central portion of the toggle support 130.

The rotation transmission part 185 may be configured to include a belt or a pulley instead of the gear.

An operation of the mold space adjustment mechanism 180 is controlled by the control device 700. The control device 700 drives the mold space adjustment motor 183, and rotates the screw nut 182. In this manner, the control device 700 adjusts the position of the toggle support 130 for holding the screw nut 182 to be rotatable with respect to a stationary platen 110, and adjusts the interval L between the stationary platen 110 and the toggle support 130.

The interval L is detected by using a mold space adjustment motor encoder 184. The mold space adjustment motor encoder 184 detects a rotation amount or a rotation direction of the mold space adjustment motor 183, and transmits a signal indicating a detection result thereof to the control device 700. The detection result of the mold space adjustment motor encoder 184 is used in monitoring or controlling the position or the interval L of the toggle support 130.

A toggle support position detector for detecting the position of the toggle support 130 and an interval detector for detecting the interval L are not limited to the mold space adjustment motor encoder 184, and a general detector can be used.

The mold space adjustment mechanism 180 adjusts the interval L by rotating one of the screw shaft 181 and the screw nut 182 which are screwed to each other. A plurality of the mold space adjustment mechanisms 180 may be used, or a plurality of mold space adjustment motors 183 may be used.

The mold clamping unit 100 of the present embodiment is a horizontal type in which the mold opening and closing direction is a horizontal direction, but may be a vertical type in which the mold opening and closing direction is an upward-downward direction.

In addition, the mold clamping unit 100 of the present embodiment has the mold clamping motor 160 as a drive source. However, a hydraulic cylinder may be provided instead of the mold clamping motor 160. In addition, the mold clamping unit 100 may have a linear motor for mold opening and closing, and may have an electromagnet for mold clamping.

### Ejector Unit

The ejector unit 200 ejects a molding product from the mold unit 10. The ejector unit 200 has an ejector motor 210, a motion conversion mechanism 220, and an ejector rod 230.

Hereinafter, in describing the ejector unit 200, as in the description of the mold clamping unit 100, a moving direction of the movable platen 120 during the mold closing (rightward direction in FIG. 1) will be defined as forward, and a moving direction of the movable platen 120 during the mold opening (leftward direction in FIG. 1) will be defined as rearward.

The ejector motor 210 is attached to the movable platen 120. The ejector motor 210 is directly connected to the motion conversion mechanism 220, but may be connected to the motion conversion mechanism 220 via a belt or a pulley.

The motion conversion mechanism 220 converts a rotary motion of the ejector motor 210 into a linear motion of the ejector rod 230. The motion conversion mechanism 220 includes a screw shaft and a screw nut screwed to the screw shaft. A ball or a roller may be interposed between the screw shaft and the screw nut.

The ejector rod 230 is freely advanced and retreated in a through-hole of the movable platen 120. A front end portion of the ejector rod 230 comes into contact with a movable member 15 disposed to be freely advanced and retreated inside the movable mold 12. The front end portion of the ejector rod 230 may be connected to or may not be connected to the movable member 15.

The ejector unit 200 performs an ejection process under the control of the control device 700.

In the ejection process, the ejector motor 210 is driven so that the ejector rod 230 is advanced from a standby position to an ejection position at a set speed. In this manner, the movable member 15 is advanced to eject the molding product. Thereafter, the ejector motor 210 is driven so that the ejector rod 230 is retreated at a set speed, and the movable member 15 is retreated to an original standby position. For example, a position or a speed of the ejector rod 230 is detected by using an ejector motor encoder 211. The ejector motor encoder 211 detects the rotation of the ejector motor 210, and transmits a signal indicating a detection result thereof to the control device 700.

An ejector rod position detector for detecting the position of the ejector rod 230, and an ejector rod speed detector for measuring the speed of the ejector rod 230 are not limited to the ejector motor encoder 211, and a general detector can be used.

### Injection Unit

The injection unit 300 is installed in slide base 301 which is freely advanced and retreated with respect to the frame Fr, and is freely advanced and retreated with respect to the mold unit 10. The injection unit 300 touches the mold unit 10, and fills the cavity space 14 inside the mold unit 10 with the molding material. For example, the injection unit 300 has a cylinder 310, a nozzle 320, a screw 330, a plasticizing motor 340, an injection motor 350, and a pressure detector 360.

Hereinafter, in describing the injection unit 300, a direction in which the injection unit 300 is moved close to the mold unit 10 (leftward direction in FIG. 1) will be defined as forward, and a direction in which the injection unit 300 is separated from the mold unit 10 (rightward direction in FIG. 1) will be defined as rearward.

The cylinder 310 heats the molding material supplied into the cylinder 310 from a feed port 311. For example, the molding material includes a resin. For example, the molding material is formed in a pellet shape, and is supplied to the feed port 311 in a solid state. The feed port 311 is formed in a rear portion of the cylinder 310. A cooler 312 such as a water-cooling cylinder is provided on an outer periphery in a rear portion of the cylinder 310. In front of the cooler 312, a heating unit 313 such as a band heater and a temperature measurer 314 are provided on the outer periphery of the cylinder 310.

The cylinder 310 is divided into a plurality of zones in an axial direction (rightward-leftward direction in FIG. 1) of the cylinder 310. The heating unit 313 and the temperature measurer 314 are provided in each of the zones. In each of the zones, the control device 700 controls the heating unit 313 so that a measurement temperature of the temperature measurer 314 reaches a set temperature.

The nozzle 320 is provided in a front end portion of the cylinder 310, and is pressed against the mold unit 10. The heating unit 313 and the temperature measurer 314 are provided on an outer periphery of the nozzle 320. The control device 700 controls the heating unit 313 so that a measurement temperature of the nozzle 320 reaches a set temperature.

The screw 330 is disposed to be rotatable and to be freely advanced and retreated inside the cylinder 310. When the screw 330 is rotated, the molding material is fed forward along a helical groove of the screw 330. The molding material is gradually melted by heat from the cylinder 310 while being fed forward. As the liquid molding material is fed forward of the screw 330 and is accumulated in the front portion of the cylinder 310, the screw 330 is retreated. Thereafter, when the screw 330 is advanced, the liquid molding material accumulated in front of the screw 330 is injected from the nozzle 320, and the inside of the mold unit 10 is filled with the liquid molding material.

As a backflow prevention valve for preventing a backflow of the molding material fed rearward from the front of the screw 330 when the screw 330 is pressed forward, a backflow prevention ring 331 is attached to a front portion of the screw 330 to be freely advanced and retreated.

The backflow prevention ring 331 is pressed rearward by the pressure of the molding material in front of the screw 330 when the screw 330 is advanced, and is relatively retreated with respect to the screw 330 to a close position (refer to FIG. 1) for closing a flow path of the molding material. In this manner, the molding material accumulated in the front of the screw 330 is prevented from flowing rearward.

On the other hand, the backflow prevention ring 331 is pressed forward by the pressure of the molding material fed forward along the helical groove of the screw 330 when the screw 330 is rotated, and is relatively advanced with respect to the screw 330 to an open position (refer to FIG. 1) for opening the flow path of the molding material. In this manner, the molding material is fed forward of the screw 330.

The backflow prevention ring 331 may be either a co-rotation type rotating together with the screw 330 or a non-co-rotation type that does not rotate together with the screw 330.

The injection unit 300 may have a drive source that advances and retreats the backflow prevention ring 331 with respect to the screw 330 between the open position and the close position.

The plasticizing motor 340 rotates the screw 330. The drive source for rotating the screw 330 is not limited to the plasticizing motor 340, and may be a hydraulic pump, for example.

The injection motor 350 advances and retreats the screw 330. A motion conversion mechanism that converts a rotary motion of the injection motor 350 into a linear motion of the screw 330 is provided between the injection motor 350 and the screw 330. For example, the motion conversion mechanism has a screw shaft and a screw nut screwed to the screw shaft. A ball or a roller may be provided between the screw shaft and the screw nut. The drive source that advances and retreats the screw 330 is not limited to the injection motor 350, and may be a hydraulic cylinder, for example.

The pressure detector 360 detects a pressure transmitted between the injection motor 350 and the screw 330. The pressure detector 360 is provided in a force transmission channel between the injection motor 350 and the screw 330, and detects the pressure acting on the pressure detector 360.

The pressure detector 360 transmits a signal indicating a detection result thereof to the control device 700. The detection result of the pressure detector 360 is used in controlling or monitoring the pressure received by the screw 330 from the molding material, a back pressure acting on the screw 330, or the pressure acting on the molding material from the screw 330.

The injection unit 300 performs a plasticizing process, a filling process, and a holding pressure process under the control of the control device 700.

In the plasticizing process, the plasticizing motor 340 is driven to rotate the screw 330 at a set rotation speed, and the molding material is fed forward along the helical groove of the screw 330. Through the process, the molding material is gradually melted. As the liquid molding material is fed forward of the screw 330 and is accumulated in the front portion of the cylinder 310, the screw 330 is retreated. For example, a rotation speed of the screw 330 is measured by using a plasticizing motor encoder 341. The plasticizing motor encoder 341 detects the rotation of the plasticizing motor 340, and transmits a signal indicating a detection result thereof to the control device 700.

A screw rotation speed detector for measuring the rotation speed of the screw 330 is not limited to the plasticizing motor encoder 341, and a general detector can be used.

In the plasticizing process, the injection motor 350 may be driven to apply a preset back pressure to the screw 330 in order to limit sudden retreat of the screw 330. The back pressure applied to the screw 330 is detected by using the pressure detector 360, for example. The pressure detector 360 transmits a signal indicating a detection result thereof to the control device 700. When the screw 330 is retreated to a plasticizing completion position and a predetermined amount of the molding material is accumulated in front of the screw 330, the plasticizing process is completed.

In the filling process, the injection motor 350 is driven to advance the screw 330 at a set speed, and the liquid molding material accumulated in front of the screw 330 fills the cavity space 14 inside the mold unit 10. The position or the speed of the screw 330 is detected by using an injection motor encoder 351, for example. The injection motor encoder 351 detects the rotation of the injection motor 350, and transmits a signal indicating a detection result thereof to the control device 700. When the position of the screw 330 reaches a set position, the filling process is switched to a holding pressure process (so-called V/P switching). The position where the V/P switching is performed will be referred to as a V/P switching position. The set speed of the screw 330 may be changed depending on the position or a time of the screw 330.

When the position of the screw 330 reaches the set position in the filling process, the screw 330 may be temporarily stopped at the set position, and thereafter, the V/P switching may be performed. Immediately before the V/P switching, instead of stopping the screw 330, the screw 330 may be advanced at a low speed, or may be retreated at a low speed. In addition, a screw position detector for detecting the position of the screw 330 and a screw speed detector for measuring the speed of the screw 330 are not limited to the injection motor encoder 351, and a general detector can be used.

In the holding pressure process, the injection motor 350 is driven to press the screw 330 forward. A pressure (hereinafter, also referred to as a “holding pressure”) of the molding material in a front end portion of the screw 330 is maintained at a set pressure, and the molding material remaining inside the cylinder 310 is pressed toward the mold unit 10. The molding material which is insufficient due to cooling shrinkage inside the mold unit 10 can be replenished. The holding pressure is detected by using the pressure detector 360, for example. The pressure detector 360 transmits a signal indicating a detection result thereof to the control device 700. A set value of the holding pressure may be changed depending on an elapsed time from the start of the holding pressure process.

In the holding pressure process, the molding material in the cavity space 14 inside the mold unit 10 is gradually cooled, and when the holding pressure process is completed, an inlet of the cavity space 14 is closed by the solidified molding material. This state is referred to as gate seal, and prevents the backflow of the molding material from the cavity space 14. After the holding pressure process, a cooling process starts. In the cooling process, the molding material inside the cavity space 14 is solidified. In order to shorten a molding cycle time, the plasticizing process may be performed during the cooling process.

The injection unit 300 of the present embodiment is an in-line screw type, but may be a pre-plastic type. The injection unit of the pre-plastic type supplies the molding material melted inside a plasticizing cylinder to an injection cylinder, and the molding material is injected into the mold unit from the injection cylinder. The screw inside the plasticizing cylinder is disposed to be rotatable or to be rotatable and freely advanced and retreated. A plunger is disposed to be freely advanced and retreated inside the injection cylinder.

In addition, the injection unit 300 of the present embodiment is a horizontal type in which the axial direction of the cylinder 310 is a horizontal direction, but may be a vertical type in which the axial direction of the cylinder 310 is an upward-downward direction. The mold clamping unit combined with the injection unit 300 of the vertical type may be the vertical type or the horizontal type. Similarly, the mold clamping unit combined with the injection unit 300 of the horizontal type may be the horizontal type or the vertical type.

### Moving Unit

The moving unit 400 advances and retreats the injection unit 300 with respect to the mold unit 10. In addition, the moving unit 400 presses the nozzle 320 against the mold unit 10, thereby generating a nozzle touch pressure. The moving unit 400 has a hydraulic pump 410, a motor 420 serving as a drive source, and a hydraulic cylinder 430 serving as a hydraulic actuator.

Hereinafter, in describing the moving unit 400, as in the description of the injection unit 300, a direction in which the injection unit 300 is moved close to the mold unit 10 (leftward direction in FIG. 1) will be defined as forward, and a direction in which the injection unit 300 is separated from the mold unit 10 (rightward direction in FIG. 1) will be defined as rearward.

The moving unit 400 is disposed on one side of the cylinder 310 of the injection unit 300 in FIG. 1, but may be disposed on both sides of the cylinder 310, or may be disposed symmetrically around the cylinder 310.

The hydraulic pump 410 has a first port 411 and a second port 412. The hydraulic pump 410 is a pump that can rotate in both directions, and switches rotation directions of the motor 420. In this manner, a hydraulic fluid (for example, oil) is suctioned from any one of the first port 411 and the second port 412, and is discharged from the other, thereby generating a hydraulic pressure. In addition, the hydraulic pump 410 can suction the hydraulic fluid from a tank, and can discharge the hydraulic fluid from any one of the first port 411 and the second port 412.

The motor 420 operates the hydraulic pump 410. The motor 420 drives the hydraulic pump 410 in a rotation direction and with a rotation torque in response to a control signal transmitted from the control device 700. The motor 420 may be an electric motor, or may be an electric servo motor.

The hydraulic cylinder 430 has a cylinder body 431, a piston 432, and a piston rod 433. The cylinder body 431 is fixed to the injection unit 300. The piston 432 partitions the inside of the cylinder body 431 into a front chamber 435 serving as a first chamber and a rear chamber 436 serving as a second chamber. The piston rod 433 is fixed to the stationary platen 110.

The front chamber 435 of the hydraulic cylinder 430 is connected to the first port 411 of the hydraulic pump 410 via a first flow path 401. The hydraulic fluid discharged from the first port 411 is supplied to the front chamber 435 via the first flow path 401. In this manner, the injection unit 300 is pressed forward. The injection unit 300 is advanced, and the nozzle 320 is pressed against the stationary mold 11. The front chamber 435 functions as a pressure chamber that generates the nozzle touch pressure of the nozzle 320 via the pressure of the hydraulic fluid supplied from the hydraulic pump 410.

On the other hand, the rear chamber 436 of the hydraulic cylinder 430 is connected to the second port 412 of the hydraulic pump 410 via a second flow path 402. The hydraulic fluid discharged from the second port 412 is supplied to the rear chamber 436 of the hydraulic cylinder 430 via the second flow path 402. In this manner, the injection unit 300 is pressed rearward. The injection unit 300 is retreated, and the nozzle 320 is separated from the stationary mold 11.

The moving unit 400 is not limited to the configuration including the hydraulic cylinder 430. For example, instead of the hydraulic cylinder 430, an electric motor and a motion conversion mechanism that converts a rotary motion of the electric motor into a linear motion of the injection unit 300 may be used.

### Control Device

The control device 700 directly transmits a control signal to the mold clamping unit 100, the ejector unit 200, the injection unit 300, and the moving unit 400, and performs various controls relating to the injection molding machine 1.

The control device 700 may be realized by any hardware or a combination of any hardware and software. For example, the control device 700 is configured to mainly include a computer having a central processing unit (CPU) 701, a memory device 702, an auxiliary storage device 703, and an interface device 704 for input and output. The control device 700 performs various types of controls by causing the CPU 701 to execute a program installed in the auxiliary storage device 703. In addition, the control device 700 receives a signal from the outside or outputs a signal to the outside through the interface device 704. For example, the control device 700 is communicably connected to the management device 2 through the communication line NW based on the interface device 704. In addition, the control device 700 may be communicably connected to (the control device 700 of) the other injection molding machine 1 through the communication line NW based on the interface device 704.

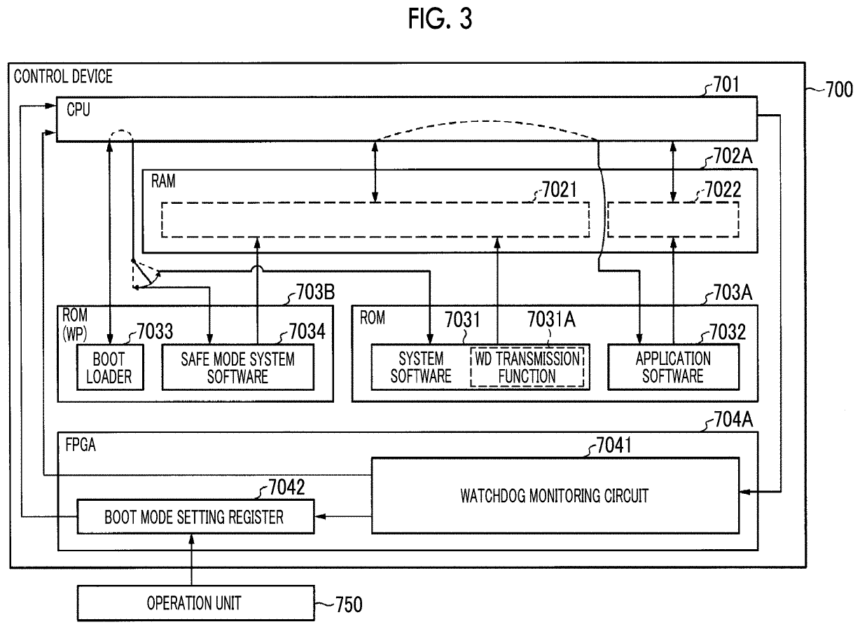

The memory device 702 includes, for example, a random access memory (RAM) 702A (refer to FIGS. 3, 5, and 7).

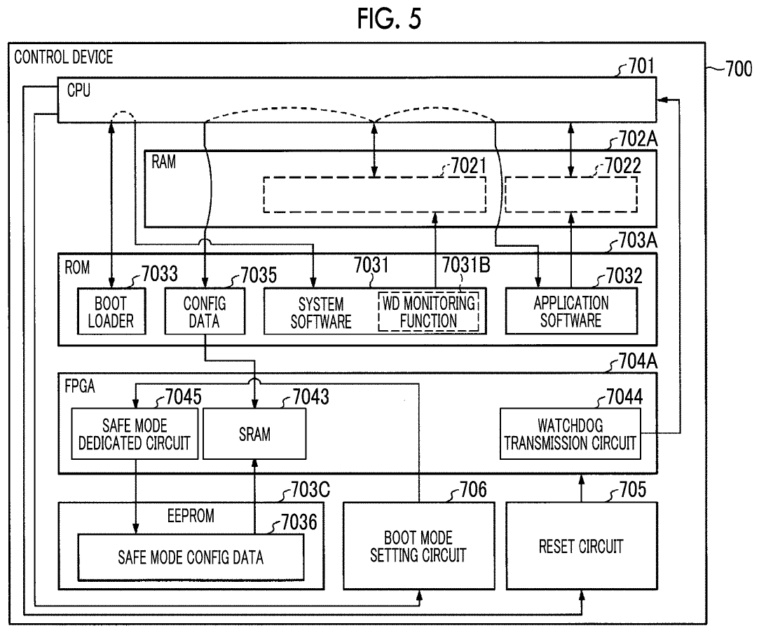

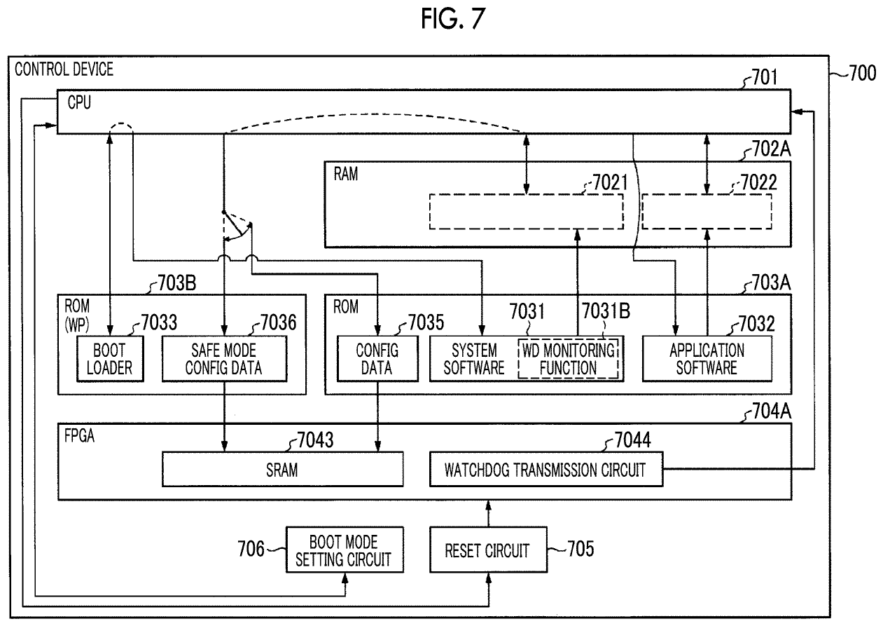

The auxiliary storage device 703 includes, for example, a read only memory (ROM) 703A (refer to FIGS. 3, 5, and 7 described later). In addition, the auxiliary storage device 703 may include a ROM 703B (refer to FIGS. 3 and 7 described later). In addition, the auxiliary storage device 703 may include, for example, an electrically erasable programmable read only memory (EEPROM) 703C (refer to FIG. 5 described later).

The interface device 704 includes, for example, a field programmable gate array (FPGA) 704A for communication (refer to FIGS. 3, 5, and 7 described later).

The function of the control device 700 may be realized by, for example, only one controller, or may be shared by a plurality of controllers.

The control device 700 repeatedly manufactures a molding product by causing the injection molding machine 1 to repeatedly perform a mold closing process, a mold clamping process, a mold opening process, and the like. In addition, the control device 700 causes the injection unit 300 to perform a plasticizing process, a filling process, a holding pressure process, and the like during the mold clamping process.

A series of operations for obtaining the molding products, for example, an operation from the start of the plasticizing process performed by the injection unit 300 to the start of the subsequent plasticizing process performed by the injection unit 300 is referred to as a “shot” or a “molding cycle”. In addition, a time required for one shot is referred to as a “molding cycle time”.

One molding cycle is configured to include, for example, a plasticizing process, a mold closing process, a mold clamping process, a filling process, a holding pressure process, a cooling process, a mold opening process, and an ejection process in this order. This order is an order of starting each process. In addition, the filling process, the holding pressure process, and the cooling process are performed until the mold clamping process is completed after the mold clamping process starts. In addition, the completion of the mold clamping process coincides with the start of the mold opening process.

A plurality of the processes may be simultaneously performed in order to shorten the molding cycle time. For example, the plasticizing process may be performed during the cooling process of the previous molding cycle. In this case, the mold closing process may be performed in an initial stage of the molding cycle. In addition, the filling process may start during the mold closing process. In addition, the ejection process may start during the mold opening process. In addition, in a case where an on-off valve for opening and closing the flow path of the nozzle 320 of the injection unit 300 is provided, the mold opening process may be started during the plasticizing process. The reason is as follows. Even when the mold opening process starts during the plasticizing process, when the on-off valve closes the flow path of the nozzle 320, the molding material does not leak from the nozzle 320.

The control device 700 is connected to an operation unit 750, a display unit 760, and the like.

The operation unit 750 receives an operation input relating to the injection molding machine 1 from a user, and outputs a signal corresponding to the operation input to the control device 700.

The display unit 760 displays various images under the control of the control device 700.

The display unit 760 displays, for example, an operation screen relating to the injection molding machine 1 in response to the operation input in the operation unit 750.

The operation screen displayed on the display unit 760 is used for the setting relating to the injection molding machine 1. For example, the setting relating to the injection molding machine 1 includes setting of the molding conditions (specifically, an input of a set value) relating to the injection molding machine 1. In addition, for example, the setting includes setting relating to selection of a type of a detection value of various sensors, which is recorded as logging data during the molding operation and relates to the injection molding machine 1. In addition, for example, the setting includes setting of specifications (for example, a type of an actual value to be displayed or a display method) in which the detection value (actual value) of various sensors relating to the injection molding machine 1 during the molding operation is displayed on the display unit 760. A plurality of the operation screens are prepared, and may be displayed by switching of the display unit 760, or may be displayed in an overlapping manner. A user can perform the setting (including the input of the set value) relating to the injection molding machine 1 by operating the operation unit 750 while looking at the operation screen displayed on the display unit 760.

In addition, the display unit 760 displays, for example, an information screen that provides the user with various information according to the operation on the operation screen under the control of the control device 700. A plurality of information screens are prepared, and may be displayed by switching of the display unit 760, or may be displayed in an overlapping manner. For example, the display unit 760 displays a setting content relating to the injection molding machine 1 (for example, setting content relating to the molding conditions of the injection molding machine 1). In addition, for example, the display unit 760 displays management information (for example, information relating to an actual result of the operations of the injection molding machine 1).

For example, the operation unit 750 and the display unit 760 may be configured to function as a touch panel type display, and may be integrated with each other.

Although the operation unit 750 and the display unit 760 of the present embodiment are integrated with each other, both of these may be independently provided. In addition, a plurality of the operation units 750 may be provided. Instead of, or in addition to the operation unit 750, another input device that accepts an input other than the user's operation input may be provided. Other input units may include, for example, a voice input unit that accepts a user's voice input, a gesture input unit that accepts a user's gesture input, and the like. The voice input unit includes, for example, a microphone and the like. In addition, the gesture input unit includes, for example, a camera (imaging device) and the like.

### Management Device

As described above, the management device 2 is communicably connected to the injection molding machine 1 through the communication line NW.

For example, the management device 2 is an on-premises server or a cloud server installed in a remote location such as a management center outside a factory where the injection molding machine 1 is installed. In addition, for example, the management device 2 may be an edge server installed inside the factory or at a place relatively close to the factory where the injection molding machine 1 is installed (for example, a radio base station or a station building close to the factory). In addition, the management device 2 may be a stationary terminal device (for example, desktop computer terminal) in the factory where the injection molding machine 1 is installed. In addition, the management device 2 may be a mobile terminal (for example, a smartphone, a tablet terminal, or a laptop computer terminal) that can be carried by a manager of the injection molding machine 1.

For example, the management device 2 can identify the operation state of the injection molding machine 1 and manage the operation state of the injection molding machine 1 based on the data transmitted (uploaded) from the injection molding machine 1. In addition, the management device 2 can perform various diagnoses such as an abnormality diagnosis of the injection molding machine 1, based on the identified operation state of the injection molding machine 1.

In addition, for example, the management device 2 may transmit control data (for example, data relating to various setting conditions such as molding conditions) to the injection molding machine 1 through the communication line NW. In this manner, the management device 2 can control the operation of the injection molding machine 1.

In addition, for example, the management device 2 achieves version matching with the injection molding machine 1, from the viewpoint of compatibility of data received from the injection molding machine 1 or data transmitted to the injection molding machine 1 with the injection molding machine 1. Specifically, a range of versions of the injection molding machine 1 (hereinafter, “version matching range”) capable of ensuring data compatibility with the management device 2 may be defined, and the management device 2 may confirm whether the versions of the plurality of injection molding machines 1 are within the range at each predetermined timing. The predetermined timing may be, for example, when any injection molding machine 1 of the plurality of injection molding machines 1 is booted. For example, when the injection molding machine 1 is booted, the management device 2 may request the target injection molding machine 1 to transmit data relating to the version through the communication line NW, and may identify the current version of the target injection molding machine 1 based on the returned data relating to the version of injection molding machine 1. In addition, the data relating to the version of the injection molding machine 1 may be automatically transmitted from the injection molding machine 1 to the management device 2 when the injection molding machine 1 is booted. The management device 2 may confirm whether or not the current version of the target injection molding machine 1 is within the version matching range based on the data relating to the version matching range registered in an internal auxiliary storage device or the like. In addition, in a case where there is a version of the injection molding machine 1 that is out of the version matching range, the management device 2 may transmit update data for upgrading the injection molding machine 1 to the target injection molding machine 1 through the communication line NW when the software can be updated. In addition, in a case where there is a version of the injection molding machine 1 that is out of the version matching range, the management device 2 may notify the serviceman of the hardware replacement by a predetermined method (for example, by e-mail or the like), when the hardware needs to be updated (replaced).

In other words, when included in the version matching range, even if the versions of the plurality of injection molding machines 1 are different from each other, the management device 2 can operate the plurality of injection molding machines 1 through the exchange of data with each injection molding machine 1.

In addition, information (for example, table information) relating to the latest version of each of the plurality of injection molding machines 1 may be registered (stored) in the internal auxiliary storage device or the like. In this manner, the management device 2 can appropriately confirm the latest version of each of the plurality of injection molding machines 1. In addition, the management device 2 can present information on the latest version of each of the plurality of injection molding machines 1 to users such as the worker and the manager of the management device 2 through a display unit or the like installed in the own device.

### First Example of Abnormality Monitoring Inside Injection Molding Machine

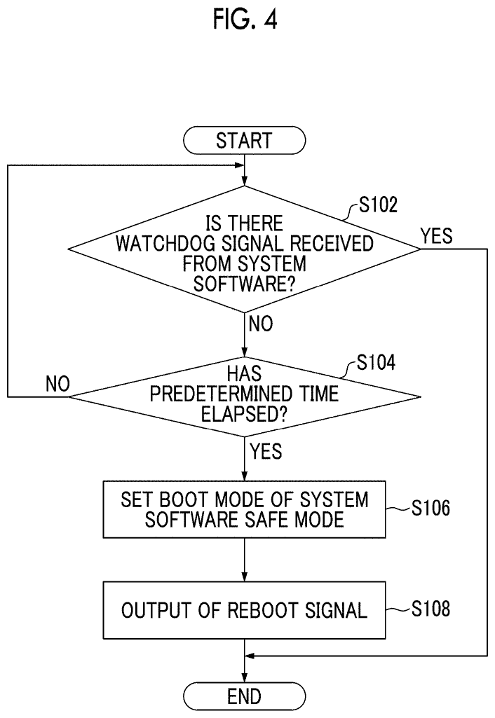

Next, with reference to FIGS. 3 and 4, a first example of abnormality monitoring relating to the injection molding machine 1 (own machine) inside the injection molding machine 1 will be described.

### Detailed Configuration of Control Device

First, the configuration details of the control device 700 according to the present example will be described.

FIG. 3 is a diagram illustrating a first example of the detailed configuration of the control device 700.

As illustrated in FIG. 3, the control device 700 includes a CPU 701, a RAM 702A, a ROM 703A, a ROM 703B, and an FPGA 704A.

The CPU 701 executes various programs recorded (installed) in the ROM 703A, and performs processing according to the contents of the programs.

The RAM 702A functions as a work area of the CPU 701. Specifically, various programs installed in the ROM 703A are loaded (decompressed) into the RAM 702A, and the CPU 701 can execute processing corresponding to the various programs while accessing the RAM 702A.

Various programs corresponding to various processing executed by the CPU 701 are installed in the ROMs 703A and 703B.

Programs such as a system software 7031 and an application software 7032 are installed in the ROM 703A.

The ROM 703B is configured to be write-protected (WP), that is, to enable write-protected setting, and in the present example, the write-protected setting is made after a predetermined program is recorded (installed). Programs such as a boot loader 7033 and a safe mode system software 7034 are installed in the ROM 703B.

The CPU 701 first reads and executes the program of the boot loader 7033 of the ROM 703B at the time of booting (for example, at the time of booting when the power of the injection molding machine 1 is turned on or at the time of rebooting based on the reception of a reboot signal described later).

The CPU 701 uses the program of the boot loader 7033 to boot a system software 7021 in a set boot mode. The boot mode includes a normal boot mode (hereinafter, “normal boot mode”) and a safe mode in which a function of the system software 7021 is restricted and booted.

In a case where the set boot mode is the “normal boot mode”, the CPU 701 loads the program of the system software 7031 of the ROM 703A into the RAM 702A by using the program of the boot loader 7033. In this manner, the CPU 701 can boot the system software 7021 in the normal boot mode. For example, the program of the system software 7031 includes a watchdog (WD) transmission function 7031A. In this manner, the CPU 701 can periodically output the watchdog signal to the outside by using the system software 7021 in the normal boot mode (that is, at predetermined time intervals).

On the other hand, in a case where the set boot mode is “safe mode”, the CPU 701 loads the program of the safe mode system software 7034 of the ROM 703B into the RAM 702A by using the program of the boot loader 7033. In this manner, the CPU 701 can boot a safe mode system software 7021. The functions of the safe mode system software 7021 are limited to those of the system software 7021 in normal boot mode. In this manner, for example, even if some abnormality occurs in the system software 7021 in the normal boot mode and the system software 7021 cannot be normally booted, the system software 7021 can be booted in such a form that the minimum function can be used by using the safe mode. For example, the safe mode system software 7021 includes minimum functions such as a function of communicating with the outside and a function of saving data received from the outside in an internal memory. On the other hand, the safe mode software does not include a function of executing a part or all of the application software 7032 on the CPU 701. That is, the CPU 701 cannot execute a part or all of the program of the application software 7032 by using the program of the safe mode system software 7021.

In addition, in a case where the system software 7021 is booted in the normal boot mode, the CPU 701 can load the application software 7032 into the RAM 702A under the control of the system software 7021. The CPU 701 can execute the program of the application software 7022 of the RAM 702A.

The FPGA 704A includes a watchdog monitoring circuit 7041 and a boot mode setting register 7042.

The watchdog monitoring circuit 7041 monitors the presence or absence of the output of the watchdog signal output from the CPU 701 to the outside according to the WD transmission function 7031A by the system software 7021 in the normal boot mode.

In a case where the watchdog signal is no longer output (receive) from the CPU 701 while the injection molding machine 1 (control device 700) is in operation, the watchdog monitoring circuit 7041 transmits a command signal (hereinafter, “safe mode setting signal”) for setting the boot mode of the system software to “safe mode” to the boot mode setting register 7042. The watchdog monitoring circuit 7041 transmits a command signal (hereinafter, “reboot signal”) instructing the CPU 701 to reboot.

The boot mode of the system software 7021 executed by the CPU 701 is set in the boot mode setting register 7042, and the setting content is notified to the CPU 701.

Normally, the “normal boot mode” is set in the boot mode setting register 7042. On the other hand, when the safe mode setting signal is received from the watchdog monitoring circuit 7041, the boot mode setting register 7042 changes the boot mode of the system software from “normal boot mode” to “safe mode” and notifies the CPU 701 of the setting content. In this manner, the CPU 701 can change the boot mode of the next system software accompanying the reboot signal from the watchdog monitoring circuit 7041 from the “normal boot mode” to the “safe mode”.

In addition, the boot mode setting register 7042 may be capable of setting (changing) the boot mode of the system software 7021 executed by the CPU 701 according to a predetermined operation input received from the operation unit 750. In this manner, for example, the user of the injection molding machine 1 can change the boot mode of the system software 7021 executed by the CPU 701 from “normal mode” to “safe mode” through the operation unit 750. Therefore, the user of the injection molding machine 1 can manually boot the system software 7021 in the safe mode by manually changing the boot mode to the “safe mode” and rebooting the CPU 701 through the operation unit 750.

### Control Processing of Control Device

Subsequently, control processing (hereinafter, “abnormality monitoring processing”) relating to abnormality monitoring by the control device 700 according to the present example will be described.

FIG. 4 is a flowchart schematically illustrating a first example of abnormality monitoring processing by the control device 700. Specifically, FIG. 4 is a flowchart which illustrates the specific example of the abnormality monitoring processing executed by the FPGA 704A in FIG. 3. This flowchart may be executed at predetermined control cycles, for example, during the execution of the system software 7021 corresponding to the normal boot mode by the CPU 701.

As illustrated in FIG. 4, in step S102, the watchdog monitoring circuit 7041 determines whether or not the latest watchdog signal is received from the system software 7021 being executed by the CPU 701. The latest watchdog signal means, for example, the first watchdog signal in the case of processing the first flowchart after booting of the injection molding machine 1 (control device 700). In addition, the latest watchdog signal means, for example, a watchdog signal output after the previous watchdog signal is received in the case of subsequent processing of the flowchart. In a case where the watchdog signal is received from the CPU 701, the watchdog monitoring circuit 7041 determines that the system software 7021 being executed by the CPU 701 is normal, and ends the current processing. On the other hand, in a case where the watchdog signal has not been received from the CPU 701, the watchdog monitoring circuit 7041 proceeds to step S104.

In step S104, the watchdog monitoring circuit 7041 determines whether or not the predetermined time has elapsed in a state where the watchdog signal has not been received, with reference to the predetermined timing. The predetermined time is a threshold at which it can be determined that an abnormality has occurred in the system software 7021 being executed by the CPU 701 and the watchdog signal cannot be transmitted. The predetermined timing may be the timing of the start of this flowchart or the timing of receiving the previous watchdog signal. In a case where the predetermined time has not elapsed, the watchdog monitoring circuit 7041 returns to step S102 and repeats the processing of steps S102 and S104. On the other hand, in a case where the predetermined time has elapsed, the watchdog monitoring circuit 7041 determines that an abnormality has occurred in the system software 7021 being executed by the CPU 701, and proceeds to step S106.

In step S106, the watchdog monitoring circuit 7041 sets the boot mode of the system software of the CPU 701 to “safe mode” through the boot mode setting register 7042. Specifically, the watchdog monitoring circuit 7041 transmits a safe mode setting signal to the boot mode setting register 7042. In this manner, the boot mode setting register 7042 can change the boot mode of the system software to “safe mode” according to the reception of the safe mode setting signal, and notify the CPU 701 of the setting content.

When the processing of step S106 is completed, the watchdog monitoring circuit 7041 proceeds to step S108.

In step S108, the watchdog monitoring circuit 7041 outputs a reboot signal to the CPU 701. In this manner, the CPU 701 forcibly ends the system software according to the reboot signal, reboots the system software, reads the boot loader 7033, and executes the system software. The CPU 701 can load the safe mode system software 7034 into the RAM 702A and boot the safe mode system software 7021 according to the setting content of the boot mode changed by the notification from the FPGA 704A.

When the processing of step S108 is completed, the watchdog monitoring circuit 7041 ends the processing of the current flowchart.

As described above, in the present example, the FPGA 704A can determine the presence or absence of an abnormality in the system software 7021 being executed by the CPU 701 based on the presence or absence of the watchdog signal from the CPU 701. In a case where it is determined that an abnormality has occurred in the system software 7021 being executed by the CPU 701, the FPGA 704A can boot the system software 7021 in the safe mode by the CPU 701. Therefore, for example, even in a case where an abnormality occurs in the system software 7021 corresponding to the normal boot mode and the system software 7021 freezes, the system software 7021 can be rebooted in the safe mode regardless of the user's operation.

### Action

Subsequently, the action of the control device 700 according to the present example will be described.

For example, the programs of the system software 7031 and the application software 7032 installed in the ROM 703A may be updated as appropriate. The procedure for updating the program installed in the ROM 703A is, for example, the following (A1) to (A3).

(A1) The control device 700 receives update program data (for example, differential data of a portion to be replaced) distributed from a host control device inside the injection molding machine 1, the management device 2 of the injection molding machine 1, and the like (hereinafter, comprehensively or individually “host device”).

(A2) The control device 700 installs the update program data in the ROM 703A at a predetermined timing.

(A3) The control device 700 reboots the CPU 701 at a predetermined timing after the installation of the update program data is completed.

In this manner, the CPU 701 can boot the system software 7021 and the application software 7022 by using the system software 7031 and the application software 7032 in which the update program data is reflected.

In a case where installation processing of the update program data is performed in the ROM 703A according to the procedure (A2), the control device 700 may transmit a notification (signal) relating to the execution of the installation processing of the update program data to the host device. In this manner, the host device can identify that the installation processing of the delivered update program data has been performed.

The distribution of the update program data may be automatically started, for example, according to a push notification from the transmission source to the control device 700. In addition, the distribution of the update program data may be started by a manual instruction by the user through the operation unit 750. In addition, the installation processing of the update program data may be automatically started at a predetermined timing (for example, when the first injection molding machine 1 (control device 700) is stopped (for example, when the power is turned off) after the reception of the update program data is completed). In addition, the installation processing of the update program data may be started, for example, by a manual instruction by the user through the operation unit 750. In addition, the rebooting of the CPU 701 after the installation of the update program data may be automatically started, or may be started by a manual instruction by the user through the operation unit 750. Hereinafter, the same may be applied to the distribution of update config data, the installation processing, and the rebooting of the FPGA 704A, which will be described later.

However, for example, due to the influence of a communication failure or the like, the download of the program data for updating the system software 7031 may fail, and the incomplete update program data or the like may be installed. In addition, even when the program data for updating the system software 7031 is successfully downloaded, the installation processing may not be appropriately completed, and the incomplete update program data or the like may be installed. In this case, when the system software 7021 is rebooted due to the rebooting of the CPU 701 in the above procedure (A3), the system software 7021 may not be able to be normally booted on the CPU 701. Similarly, the download of the program data for updating the application software 7032 may fail, and the incomplete update program data or the like may be installed. In addition, even if the program data for updating the application software 7032 is successfully downloaded, the installation processing may not be appropriately completed, and the incomplete update program data or the like may be installed. In this case, when the system software 7021 is rebooted due to the rebooting of the CPU 701 in the above procedure (A3), the defective application software 7032 program may affect the system software 7021 and repeatedly reboot the system software 7021. As a result, the system software 7021 may not be able to be normally booted.

In addition, the distributed program data itself for updating the system software 7031 and the application software 7032 may include a defect such as a serious bug. Also in this case, as in the above case, there is a possibility that the system software 7021 cannot be normally booted.

On the other hand, in the present example, the FPGA 704A (watchdog monitoring circuit 7041) can determine the presence or absence of the watchdog signal transmitted from the system software 7021 executed by the CPU 701 (step S102 in FIG. 4). Therefore, the FPGA 704A can identify an abnormality that the system software 7021 cannot be normally booted (NO in step S104 in FIG. 4) because the watchdog signal is not received when the CPU 701 is rebooted in the above procedure (A3). The FPGA 704A (watchdog monitoring circuit 7041) can automatically boot the system software 7021 executed by the CPU 701 in the safe mode according to the abnormality (steps S106 and S108). In this manner, it is possible to save the trouble of a serviceman or the like visiting the injection molding machine 1 and manually booting the system software 7021 of the CPU 701 in the safe mode in a situation where the system software 7021 of the CPU 701 cannot be normally booted. Therefore, for example, even if a serviceman does not visit to the injection molding machine 1 to deal with the failure of updating the system software 7031 or the application software 7032, for example, the same measures can be taken from the host device such as a host control device or a management device 2.

For example, in a case where the system software 7021 is rebooted in the safe mode by the reboot signal from the FPGA 704A (watchdog monitoring circuit 7041), the CPU 701 may automatically transmit a notification signal indicating that the system has been rebooted in the safe mode to the host device. In this manner, the host device can identify that some abnormality has occurred at the first booting after the update processing of the system software 7031 or the application software 7032. Therefore, the host device can perform processing for booting the system software 7021 executed on the CPU 701 in the normal boot mode according to the reception of the notification signal from the control device 700 (CPU 701).

For example, in a case where it is determined that the cause of the update failure of the system software 7031 or the application software 7032 is a download failure or an installation processing failure, the host device may try to reinstall the update program data. This is because it is not a defect in the update program data itself. The host device may determine that the cause of the update failure is the failure of the download or the installation processing, for example, in a case where the update is successful in most of the injection molding machines 1 among the plurality of injection molding machines 1. Specifically, the host device may redistribute the update program data to the control device 700 and instruct the reinstallation of the program data for updating the system software 7031 or the application software 7032. In this manner, the host device can shift the injection molding machine 1 (control device 700) that has failed to update the system software 7031 or the application software 7032 to a state where the latest functions can be used at an earlier stage. Therefore, for example, due to the failure to update the system software 7031 of a part of the injection molding machines 1 among the plurality of injection molding machines 1, it is possible to suppress the situation where the deployment of all the latest functions to the injection molding machine 1 is delayed and the production efficiency as a whole is lowered.

In addition, for example, in a case where it is determined that the cause of the update failure of the system software 7031 or the application software 7032 is a defect in the update program data, the host device may try reinstalling to restore to the program data before the update. For example, in a case where the update fails in most of the injection molding machines 1 among the plurality of injection molding machines 1, the host device may determine that the cause of the update failure is a defect in the program data for updating. Specifically, the host device may distribute the program data of the old version before the update to the control device 700 and instruct the installation of the program data of the old version of the system software 7031 or the application software 7032. In addition, in a case where the control device 700 is configured to continuously hold the program data of the old version during the installation processing of the update program data, the host device may instruct the installation processing of the held program data of the old version to the control device 700. The host device may wait for the completion of the update program data in which the defect has been corrected, and then distribute the update program data (corrected version) to the control device 700.

In addition, for example, the host device may try reinstalling to restore to the program data before the update once, regardless of the cause of the update failure of the system software 7031 or the application software 7032. The host device may redistribute the update program data to the control device 700 after waiting for the update program data to be verified to be free of defects.

In addition, in the present example, the FPGA 704A can receive a watchdog signal periodically transmitted from the system software 7021 executed on the CPU 701. In this manner, the FPGA 704A can identify, for example, an abnormal state where some abnormality occurs in the system software 7021 corresponding to the normal boot mode and the watchdog signal cannot be transmitted at a predetermined timing. In addition, the FPGA 704A can identify, for example, a state where some abnormality occurs in the application software 7022, affects the operation of the system software 7021, and the watchdog signal cannot be transmitted at a predetermined timing. Therefore, the FPGA 704A can reboot the system software 7021 of the CPU 701 in the safe mode according to the occurrence of the abnormality, regardless of the type of the abnormality relating to the system software 7021 or the application software 7022.

As described above, in the present example, the FPGA 704A (an example of the monitoring unit) monitors the abnormality in the CPU 701 (an example of the information processing unit). In a case where an abnormality occurs in the CPU 701, the FPGA 704A reboots the CPU 701 in a safe mode (an example of a predetermined boot mode) having a more limited function than the normal boot mode. Specifically, in a case where an abnormality occurs in the system software 7021 or the application software 7022 executed on the CPU 701, the FPGA 704A reboots the system software 7021 on the CPU 701 using the program of the system software 7034 (an example of the second program) for the safe mode having a more limited function than the program of the system software 7031 (an example of the first program) corresponding to the normal boot mode.

In this manner, in a case where an abnormality occurs in the CPU 701 (system software 7021), the injection molding machine 1 can automatically restore the CPU 701 (system software 7021) under the control of the FPGA 704A.

In addition, for example, in a case of updating the program of system software 7031, the old program is saved, and in a case where there is a failure with the operation of the new program after the update, it is also possible to adopt a configuration that realizes automatic recovery by reading the old program and rebooting the old program. However, in a case where this configuration is adopted, while it is possible to deal with the situation where the CPU 701 cannot be booted due to a defect of the new program after the update, for example, even when another abnormality in the CPU 701 occurs, the CPU 701 may not be automatically restored from the failure.

On the other hand, in the present example, even in a case where what type of abnormality occurs in the system software 7021 executing on the CPU 701, the control device 700 can automatically reboot the system software 7021 in the safe mode in which the functions are limited to the minimum. Therefore, in a case where an abnormality occurs in the CPU 701, the injection molding machine 1 can more appropriately automatically restore the CPU 701 in a form capable of dealing with various abnormalities that may occur in the CPU 701.

In addition, in the present example, in a case where the device is rebooted in the safe mode by the FPGA 704A, the CPU 701 may notify a host device (an example of a host information processing unit) that the device is rebooted in the safe mode.

In this manner, the CPU 701 can make the host device identify that the device has automatically restored from some abnormality and urge the response to the abnormality.

In addition, in the present example, the host device may be configured to be able to update the program data (an example of data relating to processing of the information processing unit) such as the system software 7031 and the application software 7032. For example, the host device can distribute the update program data to the control device 700 and instruct the ROM 703A to install the program data.

In this manner, the CPU 701 can urge the host device processing of returning the system software 7031, the application software 7032, or the like, which has failed to update, to a normal state where the software can be booted in the normal boot mode by performing the above notification.

In addition, in the present example, in a case where the CPU 701 notifies that the system software 7021 or the application software 7032 has been rebooted in the safe mode after updating the program data, the host device may perform processing for booting the CPU 701 in the normal boot mode. For example, in a case where it is determined that the cause is a download failure or an installation failure, the host device may redistribute the program data for updating the system software 7021 or the application software 7032 and reinstall the program data. In addition, for example, the host device may distribute the program data of the old version before the update and return to the state before the update.

In this manner, specifically, the host device can automatically restore the system software 7021 of the CPU 701 so that the system software 7021 can be booted in the normal boot mode.

In addition, the CPU 701 periodically outputs a watchdog signal (an example of a predetermined signal) to the FPGA 704A under the control of the system software 7021 corresponding to the normal boot mode during operation. The FPGA 704A may determine the presence or absence of an abnormality in the CPU 701 depending on the presence or absence of the reception of the watchdog signal.

In this manner, the FPGA 704A can specifically determine the presence or absence of an abnormality in the CPU 701. In addition, the FPGA 704A can determine the presence or absence of an abnormality in the CPU 701 regardless of the type of abnormality. Therefore, the FPGA 704A can automatically reboot the CPU 701 in a situation where there is some abnormality.

The FPGA 704A may monitor an abnormality in the system software 7031 or the application software 7032 executed by the CPU 701 by another method.

### Second Example of Abnormality Monitoring Inside Injection Molding Machine

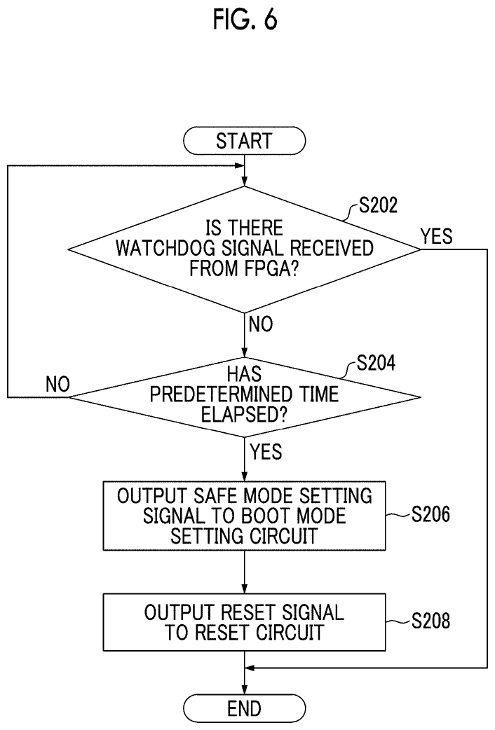

Next, with reference to FIGS. 5 and 6, a second example of abnormality monitoring relating to the injection molding machine 1 (own machine) inside the injection molding machine 1 will be described.

### Detailed Configuration of Control Device

First, the configuration details of the control device 700 according to the present example will be described.

FIG. 5 is a diagram illustrating a second example of the detailed configuration of the control device 700. Hereinafter, a part different from the first example described above will be mainly described.

As illustrated in FIG. 5, the control device 700 includes a CPU 701, a RAM 702A, a ROM 703A, an EEPROM 703C, an FPGA 704A, a reset circuit 705, and a boot mode setting circuit 706.

Unlike the first example described above, the boot loader 7033 is installed in the ROM 703A. In this manner, the CPU 701 reads the boot loader 7033 from the ROM 703A and executes the boot loader 7033 at booting.

In addition, the system software 7031 is installed in the ROM 703A as in the case of the first example described above. The program of the system software 7031 includes a watchdog (WD) monitoring function 7031B. In this manner, the CPU 701 can monitor the presence or absence of the watchdog signal output from the FPGA 704A by using the system software 7021 in the normal boot mode.

In addition, the configuration data (hereinafter, “config data”) 7035 of the FPGA 704A is installed (recorded and saved) in the ROM 703A.

The safe mode configuration data (hereinafter, “safe mode config data”) 7036 of the FPGA 704A is installed (recorded and saved) in the EEPROM 703C.

The FPGA 704A includes a static random access memory (SRAM) 7043, a watchdog transmission circuit 7044, and a safe mode dedicated circuit 7045.

In the SRAM 7043, when the FPGA 704A is booted (for example, when the power is turned on or when resetting by the reset circuit 705), the config data 7035 or the safe mode config data 7036 is loaded from the outside according to the boot mode.

The boot mode of the FPGA 704A includes a normal boot mode and a safe mode in which a function of the FPGA 704A is restricted. In a case where the FPGA 704A is booted in the normal boot mode, the FPGA 704A configures under the control of the CPU 701 (system software 7021). Specifically, the FPGA 704A receives the config data 7035 of the ROM 703A and loads the config data 7035 into the SRAM 7043 under the control of the CPU 701. On the other hand, in a case where the FPGA 704A is booted in the safe mode, the FPGA 704A configures under the own control. Specifically, the FPGA 704A receives the safe mode config data 7036 of the EEPROM 703C and loads the safe mode config data 7036 into the SRAM 7043 under the control of the safe mode dedicated circuit 7045.

The watchdog transmission circuit 7044 periodically (that is, at predetermined time intervals) outputs a watchdog signal to the outside while the FPGA 704A is in operation.

In a case where the FPGA 704A boots in the safe mode, the safe mode dedicated circuit 7045 accesses the EEPROM 703C and loads the safe mode config data 7036 into the SRAM 7043. In this manner, the safe mode dedicated circuit 7045 can boot the FPGA 704A in the safe mode.

The reset circuit 705 can reset and reboot the FPGA 704A under the control of the CPU 701 (system software 7021).

The boot mode setting circuit 706 sets the boot mode of the FPGA 704A to “normal boot mode” or “safe mode” under the control of the CPU 701 (system software 7021). In a case where the boot mode of the FPGA 704A is set to the “normal boot mode” by the boot mode setting circuit 706, the safe mode dedicated circuit 7045 does not perform an operation relating to the configuration when the FPGA 704A is booted. On the other hand, in a case where the boot mode of the FPGA 704A is set to “safe mode” by the boot mode setting circuit 706, the safe mode dedicated circuit 7045 loads the safe mode config data 7036 into the SRAM 7043 when the FPGA 704A is booted. In this manner, the safe mode dedicated circuit 7045 can control the configuration only in a case where the FPGA 704A is booted in the safe mode.

### Control Processing of Control Device

Subsequently, the abnormality monitoring processing by the control device 700 according to the present example will be described.

FIG. 6 is a flowchart schematically illustrating a second example of the abnormality monitoring processing by the control device 700. Specifically, FIG. 6 is a flowchart illustrating the specific example of the abnormality monitoring processing executed under the control of the system software 7021 by the CPU 701 in FIG. 5. This flowchart may be executed at predetermined control cycles, for example, in a state where the FPGA 704A is booted and operated in the normal boot mode.

As illustrated in FIG. 6, in step S202, the CPU 701 determines whether or not the latest watchdog signal has been received from the FPGA 704A (watchdog transmission circuit 7044). In a case where the latest watchdog signal is received from the FPGA 704A, the CPU 701 determines that the FPGA 704A is normally operating, and ends the processing of the current flowchart. On the other hand, in a case where the latest watchdog signal is not received from the FPGA 704A, the CPU 701 proceeds to step S204.

In step S204, the CPU 701 determines whether or not the predetermined time has elapsed in a state where the watchdog signal has not been received, with reference to the predetermined timing. The predetermined time is a threshold at which it can be determined that an abnormality has occurred in the operation of the FPGA 704A and the watchdog signal cannot be transmitted. The predetermined timing may be the timing of the start of this flowchart or the timing of receiving the previous watchdog signal. In a case where the predetermined time has not elapsed, the CPU 701 returns to step S202 and repeats the processing of steps S202 and S204. On the other hand, in a case where the predetermined time has elapsed, the CPU 701 determines that an abnormality has occurred in the operation of the FPGA 704A, and proceeds to step S206.

In step S206, the CPU 701 outputs a signal for setting the boot mode of the FPGA 704A to the “safe mode” (hereinafter, “safe mode setting signal”) to the boot mode setting circuit 706. In this manner, the boot mode setting circuit 706 can set the boot mode of the FPGA 704A to the “safe mode” according to the safe mode setting signal from the CPU 701.

When the processing of step S206 is completed, the CPU 701 proceeds to step S208.

In step S208, the CPU 701 outputs a signal for resetting the FPGA 704A (hereinafter, “reset signal”) to the reset circuit 705. In this manner, the reset circuit 705 can reset and reboot the FPGA 704A according to the reset signal from the CPU 701. In this case, as described above, since the boot mode of the FPGA 704A is set to the “safe mode” by the boot mode setting circuit 706, the safe mode dedicated circuit 7045 operates and the FPGA 704A is booted in the safe mode.

When the processing of step S208 is completed, the CPU 701 completes the processing of the current flowchart.

As described above, in the present example, the CPU 701 (system software 7021) can determine the presence or absence of an abnormality in the FPGA 704A based on the presence or absence of the watchdog signal from the FPGA 704A. In a case where it is determined that an abnormality has occurred in the operation of the FPGA 704A, the CPU 701 can boot the FPGA 704A in the safe mode. Therefore, for example, even in a case where an abnormality occurs in the FPGA 704A booted in the normal boot mode and the FPGA 704A freezes, the FPGA 704A can be rebooted in the safe mode regardless of the user's operation.

### Action

Subsequently, the action of the control device 700 according to the present example will be described.

For example, the config data 7035 installed in the ROM 703A may be updated as appropriate. The procedure for updating the config data 7035 of the ROM 703A is, for example, the following (B1) to (B3).

(B1) The control device 700 receives update config data (for example, differential data of a portion to be replaced) distributed from a host control device inside the injection molding machine 1, the management device 2 of the injection molding machine 1, and the like (host device).

(B2) The control device 700 installs the update config data in the ROM 703A at a predetermined timing.

(B3) The control device 700 reboots the FPGA 704A at a predetermined timing after the installation of the update config data is completed.

In this manner, the FPGA 704A can configure and boot by the config data 7035 on which the update config data is reflected.

In a case where installation processing of the update config data is performed in the ROM 703A according to the procedure (B2), the control device 700 may transmit a notification (signal) relating to the execution of the installation processing of the update config data to the host device. In this manner, the host device can identify that the installation processing of the delivered update config data has been performed.

However, for example, due to the influence of a communication failure or the like, the download of the update config data may fail and the incomplete update config data or the like may be installed. In this case, there is a possibility that the FPGA 704A cannot be booted when the FPGA 704A is rebooted in the above procedure (B3) due to a defect in the config data 7035 after improper update due to the download failure. In addition, even when the update config data is successfully downloaded, the installation processing may not be appropriately completed, and the incomplete update config data or the like may be installed. In this case, there is a possibility that the FPGA 704A cannot be normally booted when the FPGA 704A is rebooted in the above procedure (B3) due to a defect in the config data 7035 after improper update due to the failure of the installation processing.

In addition, the delivered update config data itself may include defects such as serious bugs. Also in this case, as in the above case, there is a possibility that the FPGA 704A cannot be normally booted.

On the other hand, in the present example, the CPU 701 can determine the presence or absence of the watchdog signal transmitted from the FPGA 704A (watchdog transmission circuit 7044) (step S202 in FIG. 6) using the system software 7021. Therefore, the CPU 701 can identify the abnormality that the FPGA 704A cannot be normally booted (NO in step S204 in FIG. 6) because the watchdog signal is not received when the FPGA 704A is rebooted in the above procedure (B3). The CPU 701 can automatically boot the FPGA 704A in the safe mode according to the abnormality (steps S206 and S208). In this manner, it is possible to save the trouble of a serviceman or the like visiting the injection molding machine 1 and manually booting the FPGA 704A in the safe mode in a situation where the FPGA 704A cannot be normally booted. Therefore, for example, even if a serviceman does not visit to the injection molding machine 1 to deal with the failure of updating the config data 7035, for example, the same measures can be taken from a host control device or a management device 2 (host device).

For example, in a case where the FPGA 704A is reset by the reset circuit 705 and rebooted in the safe mode, the FPGA 704A may automatically transmit a notification signal indicating that the rebooting is performed in the safe mode to the host device. In this manner, the host device can identify that some abnormality has occurred at the first booting after the update processing of the config data 7035. Therefore, the host device can perform processing for booting the FPGA 704A in the normal boot mode according to the reception of the notification signal from the control device 700 (FPGA 704A).

For example, in a case where it is determined that the cause of the update failure of the config data 7035 is a download failure or an installation processing failure, the host device may try to reinstall the update config data. This is because it is not a defect in the update config data itself. The host device may determine that the cause of the update failure is the failure of the download or the installation processing, for example, in a case where the update is successful in most of the injection molding machines 1 among the plurality of injection molding machines 1. Specifically, the host device may redistribute the update config data to the control device 700 and instruct the reinstallation of the config data for updating the config data 7035. In this manner, the control device 700 (CPU 701) can reinstall the update config data and update the config data 7035 under the control of the system software 7021. Therefore, the host device can shift the injection molding machine 1 (control device 700) that has failed to update the config data 7035 to a state where the latest functions can be used at an earlier stage. Therefore, for example, due to the failure to update the config data 7035 of a part of the injection molding machines 1 among the plurality of injection molding machines 1, it is possible to suppress the situation where the deployment of all the latest functions to the injection molding machine 1 is delayed and the production efficiency as a whole is lowered.

In addition, for example, in a case where it is determined that the cause of the update failure of the config data 7035 is a defect in the update config data, the host device may try reinstalling to restore to the config data before the update. For example, in a case where the update fails in most of the injection molding machine 1 among the plurality of injection molding machines 1, the host device may determine that the cause of the update failure is a defect in the config data for updating. Specifically, the host device may distribute the config data of the old version before the update to the control device 700 and instruct the installation of the config data of the old version. In addition, in a case where the control device 700 is configured to continuously hold the config data of the old version during the installation processing of the update config data, the host device may instruct the installation processing of the held config data of the old version to the control device 700. The host device may wait for the completion of the update config data in which the defect has been corrected, and then distribute the update config data (corrected version) to the control device 700.

In addition, for example, the host device may try reinstalling to restore to the config data before the update, regardless of the cause of the update failure of the config data 7035. The host device may redistribute the update config data to the control device 700 after waiting for the update config data to be verified to be free of defects.

In addition, in the present example, the CPU 701 can receive a watchdog signal periodically transmitted from the FPGA 704A (watchdog transmission circuit 7044). In this manner, the CPU 701 can identify, for example, an abnormal state where some abnormality occurs in the FPGA 704A and the watchdog signal cannot be transmitted at a predetermined timing. Therefore, the CPU 701 can use the system software 7021 to reboot the FPGA 704A in the safe mode according to the occurrence of the abnormality regardless of the type of the abnormality relating to the FPGA 704A.

As described above, in the present example, the CPU 701 (an example of the monitoring unit) monitors the abnormality in the FPGA 704A (an example of the information processing unit). In a case where an abnormality occurs in the CPU 701, the FPGA 704A reboots the CPU 701 in a safe mode (an example of a predetermined boot mode) having a more limited function than the normal boot mode. Specifically, the CPU 701 monitors the abnormality in the FPGA 704A by using the system software 7021 (an example of the predetermined monitoring software), and in a case where the abnormality in the FPGA 704A occurs, the CPU 701 reboots the FPGA 704A using the safe mode config data 7036 (an example of the second configuration data) corresponding to the safe mode different from the config data 7035 (an example of the first configuration data) corresponding to the normal boot mode.

In this manner, the injection molding machine 1 can automatically restore the FPGA 704A under the control of the CPU 701 (system software 7021) in a case where an abnormality occurs in the FPGA 704A.

In addition, for example, in a case where the old data is saved and there is a failure in the operation of the new data after the update when the config data 7035 of the FPGA 704A is updated, it is also possible to adopt a configuration that realizes automatic recovery by reading old data and rebooting. However, in a case where this configuration is adopted, while it is possible to deal with the situation where the FPGA 704A cannot be booted due to a defect of the new data after the update, for example, even when another abnormality in the FPGA 704A occurs, the FPGA 704A may not be automatically restored from the failure.

On the other hand, in the present example, even in a case where what type of abnormality occurs in the FPGA 704A, the control device 700 can automatically reboot the FPGA 704A in the safe mode in which the functions are limited to the minimum. Therefore, in a case where an abnormality occurs in the FPGA 704A, the injection molding machine 1 can more appropriately automatically restore the FPGA 704A in a form capable of dealing with various abnormalities that may occur in the FPGA 704A.

In addition, in the present example, in a case where the FPGA 704A is booted in the normal boot mode, the FPGA 704A receives the config data 7035 (an example of the first configuration data) from the outside (for example, ROM 703A) under the control of the system software 7021 (an example of a predetermined boot software) executed on the CPU 701. On the other hand, in a case where the FPGA 704A is booted in the safe mode, the FPGA 704A receives the safe mode config data 7036 (an example of the second configuration data) from the outside (for example, EEPROM 703C) under the control of the safe mode dedicated circuit 7045 (an example of a predetermined circuit unit) provided inside the FPGA 704A. In a case where an abnormality occurs in the FPGA 704A, the CPU 701 may output a notification (for example, a safe mode setting signal) to the FPGA 704A so that the FPGA 704A boots in the safe mode, and may reset the FPGA 704A.

In this manner, the CPU 701 configures the FPGA 704A and boots in the normal boot mode, while the CPU 701 can configure and boot in the safe mode under the control of the FPGA 704A when the FPGA 704A is abnormal.

In addition, in the present example, in a case where the FPGA 704A is rebooted in the safe mode by the CPU 701, the FPGA 704A may notify the host device (an example of a host information processing unit) that the unit has been rebooted in the safe mode.

In this manner, the FPGA 704A can make the host device identify that the device has automatically recovered from some abnormality and urge the response to the abnormality.

In addition, in the present example, the host device may be configured to be able to update the config data 7035 (an example of data relating to the processing of the information processing unit). For example, the host device is configured to be able to distribute the update config data to the control device 700 and instruct the ROM 703A to install the data.

In this manner, the FPGA 704A can urge the host device processing of returning the FPGA 704A to a normal state where the FPGA 704A can be booted in the normal boot mode by performing the above notification.

In addition, in the present example, in a case where the FPGA 704A notifies that the device has been rebooted in safe mode after updating the config data 7035, the host device may perform processing for booting the FPGA 704A in the normal boot mode. For example, in a case where it is determined that the cause is a download failure or an installation failure, the host device may redistribute the update config data and reinstall the update config data. In addition, for example, the host device or the like may distribute the program data of the old version before the update and return to the state before the update.

In this manner, the host device can automatically restore the FPGA 704A so that the FPGA 704A can be booted in the normal boot mode.

In addition, the FPGA 704A (watchdog transmission circuit 7044) periodically outputs a watchdog signal (an example of a predetermined signal) to the CPU 701 during operation. The CPU 701 may use the system software 7021 to determine the presence or absence of an abnormality in the CPU 701 depending on the presence or absence of reception of the watchdog signal.

In this manner, the CPU 701 can specifically determine the presence or absence of an abnormality in the CPU 701. In addition, the CPU 701 can determine the presence or absence of an abnormality in the CPU 701 regardless of the type of abnormality. Therefore, the FPGA 704A can automatically reboot the FPGA 704A in a situation where there is some abnormality.

The CPU 701 may monitor the abnormality in the FPGA 704A by another method.

### Third Example of Abnormality Monitoring Inside Injection Molding Machine

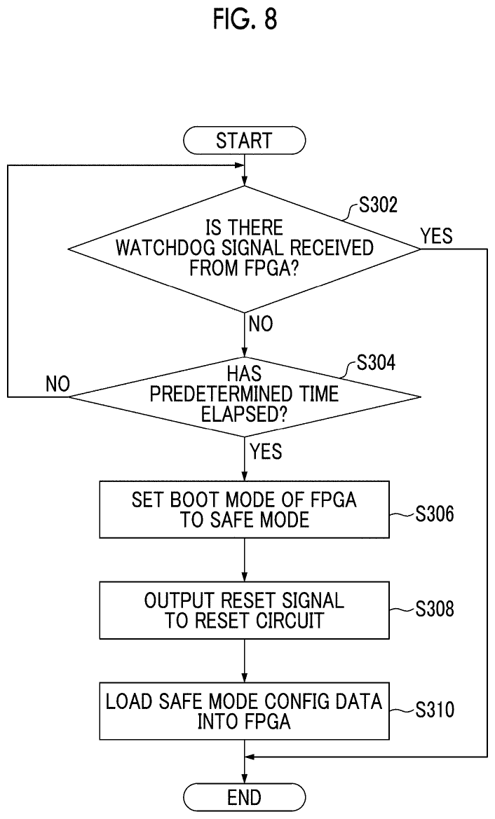

Next, with reference to FIGS. 7 and 8, a third example of abnormality monitoring relating to the injection molding machine 1 (own machine) inside the injection molding machine 1 will be described.

### Detailed Configuration of Control Device

First, the configuration details of the control device 700 according to the present example will be described.

FIG. 7 is a diagram illustrating a third example of the detailed configuration of the control device 700. Hereinafter, a part different from the first example and the second example described above will be mainly described.

As illustrated in FIG. 7, the control device 700 includes a CPU 701, a RAM 702A, a ROM 703A, a ROM 703B, an FPGA 704A, a reset circuit 705, and a boot mode setting circuit 706.

The system software 7031 is installed in the ROM 703A as in the case of the first example and the second example described above. The program of the system software 7031 includes the WD monitoring function 7031B as in the case of the second example described above. In this manner, the CPU 701 can monitor the presence or absence of the watchdog signal output from the FPGA 704A by using the system software 7021 in the normal boot mode.

In addition, the config data 7035 is installed in the ROM 703A as in the case of the second example described above.

The boot loader 7033 is installed in the ROM 703B as in the case of the first example described above.

In addition, unlike the case of the second example described above, the safe mode config data 7036 is installed in the ROM 703B.

The FPGA 704A includes the SRAM 7043 and the watchdog transmission circuit 7044.

In the SRAM 7043, as in the case of the second example described above, when the FPGA 704A is booted, the config data 7035 or the safe mode config data 7036 is loaded from the outside according to the boot mode.

The FPGA 704A configures under the control of the CPU 701 (system software 7021) regardless of the boot mode. Specifically, in a case where the FPGA 704A is booted in the normal boot mode, the FPGA 704A receives the config data 7035 of the ROM 703A and loads the config data 7035 into the SRAM 7043 under the control of the CPU 701 (system software 7021). On the other hand, in a case where the FPGA 704A is booted in the safe mode, the FPGA 704A receives the safe mode config data 7036 of the ROM 703B and loads the config data 7036 into the SRAM 7043 under the control of the CPU 701 (system software 7021).

The boot mode setting circuit 706 sets the boot mode of the FPGA 704A to “normal boot mode” or “safe mode” under the control of the CPU 701 (system software 7021). In this manner, the CPU 701 can make the boot mode setting circuit 706 set the boot mode of the FPGA 704A, and can determine the boot mode of the FPGA 704A by referring to the setting state of the boot mode setting circuit 706.

### Control Processing of Control Device

Subsequently, the abnormality monitoring processing by the control device 700 according to the present example will be described.

FIG. 8 is a flowchart schematically illustrating a third example of abnormality monitoring processing by the control device 700. Specifically, FIG. 8 is a flowchart which illustrates the specific example of the abnormality monitoring processing executed by the CPU 701 in FIG. 7. This flowchart may be executed at predetermined control cycles, for example, in a state where the FPGA 704A is booted and operated in the normal boot mode.

As illustrated in FIG. 8, steps S302 and S304 are the same as the processing of steps S202 and S204 in FIG. 6, and thus the description thereof will be omitted.

In step S304, in a case where the predetermined time has not elapsed, the CPU 701 returns to step S302 and repeats the processing of steps S302 and S304. On the other hand, in a case where the predetermined time has elapsed, the CPU 701 determines that an abnormality has occurred in the operation of the FPGA 704A, and proceeds to step S306.

In step S306, the CPU 701 sets the boot mode of the FPGA 704A to the “safe mode”. For example, the CPU 701 may set the contents in the boot mode setting circuit 706.

When the processing of step S306 is completed, the CPU 701 proceeds to step S308.

In step S308, the CPU 701 outputs a reset signal to the reset circuit 705. In this manner, the reset circuit 705 can reset the FPGA 704A according to the reset signal from the CPU 701, and the FPGA 704A can be rebooted.

When the processing of step S208 is completed, the CPU 701 proceeds to step S310.

In step S310, the CPU 701 loads the safe mode config data 7036 of the ROM 703B into the FPGA 704A (SRAM 7043) under the control of the system software 7021 in conjunction with resetting (rebooting) of the FPGA 704A. In this manner, the CPU 701 can reboot the FPGA 704A in the safe mode.

When the processing of step S310 is completed, the CPU 701 ends the processing of the current flowchart.

As described above, in the present example, as in the case of the second example described above, the CPU 701 (system software 7021) can determine the presence or absence of an abnormality in the FPGA 704A based on the presence or absence of the watchdog signal from the FPGA 704A. In a case where it is determined that an abnormality has occurred in the operation of the FPGA 704A, the CPU 701 can boot the FPGA 704A in the safe mode. Therefore, for example, even in a case where an abnormality occurs in the FPGA 704A booted in the normal boot mode and the FPGA 704A freezes, the FPGA 704A can be rebooted in the safe mode regardless of the user's operation.

### Action

Subsequently, the action of the control device 700 according to the present example will be described. Hereinafter, the action different from that of the second example described above will be mainly described.

In the present example, the CPU 701 monitors the abnormality in the FPGA 704A. In a case where an abnormality occurs in the CPU 701, the FPGA 704A reboots the CPU 701 in a safe mode having a more limited function than the normal boot mode. Specifically, the CPU 701 monitors the abnormality in the FPGA 704A by using the system software 7021, and in a case where the abnormality in the FPGA 704A occurs, the CPU 701 reboots the FPGA 704A using the safe mode config data 7036 different from the config data 7035 corresponding to the normal boot mode.

In this manner, as in the case of the second example described above, in a case where an abnormality occurs in the FPGA 704A, the injection molding machine 1 can automatically restore the FPGA 704A under the control of the CPU 701 (system software 7021). In addition, as in the case of the second example described above, even in a case where what type of abnormality occurs in the FPGA 704A, the control device 700 can be automatically rebooted in the safe mode in which the functions are limited to the minimum. Therefore, in a case where an abnormality occurs in the FPGA 704A, the injection molding machine 1 can more appropriately automatically restore the FPGA 704A in a form capable of dealing with various abnormalities that may occur in the FPGA 704A.

In addition, in the present example, in a case where the FPGA 704A is booted in the normal boot mode, the FPGA 704A receives the config data 7035 (an example of the first configuration data) from the outside (for example, ROM 703A) under the control of the system software 7021 (an example of a predetermined boot software) executed on the CPU 701. On the other hand, in a case where the FPGA 704A is booted in the safe mode, the safe mode config data 7036 (an example of the second configuration data) is received from the outside (for example, ROM 703B) under the control of the system software 7021 executed on the CPU 701. In a case where an abnormality in the FPGA 704A occurs, the CPU 701 may reset the FPGA 704A and transmit (load) the safe mode config data 7036 from the outside (ROM 703B) to the FPGA 704A (SRAM 7043) by using the system software 7021.

In this manner, the CPU 701 can determine the set boot mode of the FPGA 704A under the control of the system software 7021 and configure the FPGA 704A according to the boot mode. Therefore, it is not necessary to provide a dedicated circuit unit inside the FPGA 704A for configuring, a dedicated EEPROM for recording the safe mode config data 7036, and the like. Therefore, the configuration of the injection molding machine 1 (control device 700) can be simplified and the cost can be reduced.

### Fourth Example of Abnormality Monitoring Inside Injection Molding Machine

Next, a fourth example of abnormality monitoring relating to the injection molding machine 1 (own machine) inside the injection molding machine 1 will be described.

In the above-described first example, the FPGA 704A monitors the abnormality in the CPU 701, and in the above-described second and third examples, the CPU 701 monitors the abnormality in the FPGA 704A, but the FPGA 704A and the CPU 701 may mutually monitor the other abnormality.

For example, the configurations of the first example (FIG. 3) and the second example (FIG. 5) described above may be combined, and each of the flowcharts (abnormality monitoring processing) in FIGS. 4 and 5 may be executed by the FPGA 704A and the CPU 701.

In addition, for example, the configurations of the first example (FIG. 3) and the third example (FIG. 7) described above may be combined, and each of the flowcharts (abnormality monitoring processing) in FIGS. 4 and 8 may be executed by the FPGA 704A and the CPU 701.

In this manner, the control device 700 can realize automatic recovery from the abnormality in response to the abnormality in both the CPU 701 (system software 7021, application software 7022, or the like) and the FPGA 704A.

In addition, the control device 700 may further include another information processing unit (for example, another CPU, another FPGA, or the like) having a function different from that of the CPU 701 or FPGA 704A. The CPU 701, the FPGA 704A, and the other information processing unit may be in an aspect of mutually monitoring the other abnormality.

In this manner, the control device 700 can realize automatic recovery from the abnormality in response to all the abnormalities in the three or more information processing units to be monitored.

As described above, in the present example, the injection molding machine 1 (control device 700) is provided with a plurality of information processing units to be monitored for abnormality, and the plurality of information processing units include the CPU 701 (an example of a first information processing unit) and the FPGA 704A (an example of a second information processing unit). The CPU 701 and the FPGA 704A may monitor each other for an abnormality in the other as a monitoring unit, and in a case where an abnormality occurs in the other, reboot the other in the safe mode.

In this manner, even in a case where an abnormality occurs in either the CPU 701 or the FPGA 704A, the control device 700 can automatically restore one in which the abnormality has occurred. In addition, it is not necessary to set a dedicated monitoring unit for each of the CPU 701 and the FPGA 704A, which is a target for monitoring the abnormality. Therefore, it is possible to simplify the configuration of the injection molding machine 1 (control device 700) and reduce the cost while dealing with the abnormalities in both the CPU 701 and the FPGA 704A.

### First Example of Abnormality Monitoring Outside Injection Molding Machine

Next, a first example of abnormality monitoring relating to the injection molding machine 1 outside the injection molding machine 1 will be described.

The management device 2 (an example of the monitoring device) monitors each abnormality in the plurality of injection molding machines 1 included in the management system SYS. The abnormality to be monitored may be an abnormality relating to the control device 700, as in the case of abnormality monitoring inside the injection molding machine 1 described above. In addition, the abnormality to be monitored may be an abnormality in a device other than the control device 700 (for example, various actuators, sensors, and the like).

The abnormality to be monitored may be the same as in the present example in the case of the second example described later.

For example, the management device 2 may determine the presence or absence of an abnormality in each of the injection molding machines 1 based on the information relating to the operating status of the injection molding machine 1 transmitted (uploaded) from each of the injection molding machines 1. In addition, the management system SYS may include a peripheral unit of the injection molding machine 1 (for example, a device for transporting a completed molding product, a monitoring camera installed around the injection molding machine 1, and the like). In this case, the management device 2 may determine the presence or absence of an abnormality in the injection molding machine 1 based on the information relating to the operating status of the injection molding machine 1 transmitted (uploaded) from the peripheral unit of the injection molding machine 1.

For example, the control device 700 (CPU 701) of the injection molding machine 1 may sequentially output the watchdog signal under the control of the system software 7021 corresponding to the normal boot mode, as in the case of the first example of abnormality monitoring inside the injection molding machine 1 described above. The control device 700 may transmit the watchdog signal sequentially output to the management device 2 through the communication line NW. In this manner, the management device 2 can determine the presence or absence of an abnormality relating to the CPU 701 by the same method as in the case of the first example (FIG. 4) of the abnormality monitoring inside the injection molding machine 1 described above.

In addition, for example, the control device 700 (FPGA 704A) of the injection molding machine 1 may sequentially output the watchdog signal as in the case of the second example and the third example of abnormality monitoring inside the injection molding machine 1 described above. The control device 700 may transmit the watchdog signal sequentially output to the management device 2 through the communication line NW. In this manner, the management device 2 can determine the presence or absence of an abnormality relating to the FPGA 704A by the same method as in the case of the second example (FIG. 6) and the third example (FIG. 8) of the abnormality monitoring inside the injection molding machine 1 described above.

The method for determining the presence or absence of an abnormality in the injection molding machine 1 may be the same as in the present example in the case of the second example described later.

In a case where an abnormality relating to the injection molding machine 1 occurs, the management device 2 may transmit a predetermined signal to the target injection molding machine 1 through the communication line NW, and reboot the injection molding machine 1 in a safe mode (an example of a predetermined boot mode) in which a function of the injection molding machine 1 is restricted more than in the normal boot mode. The safe mode of the injection molding machine 1 may correspond to, for example, the safe mode of the control device 700 (system software 7021 or FPGA 704A) that controls the injection molding machine 1. In this case, the function of the injection molding machine 1 is restricted according to the operation of the system software 7021 or the FPGA 704A corresponding to the safe mode.

The contents relating to the safe mode of the injection molding machine 1 may be the same as in the present example in the case of the second example described later.

For example, the predetermined signal transmitted from the management device 2 to the injection molding machine 1 may include a signal for setting the boot mode of the system software of the CPU 701 to a “safe mode” through the boot mode setting register 7042 in FIG. 3 described above. In addition, the predetermined signal transmitted from the management device 2 to the injection molding machine 1 may further include a reboot signal for rebooting the CPU 701. In this manner, the management device 2 can automatically reboot the CPU 701 (system software 7021) in the safe mode by the same method as in the first example (FIG. 4) of abnormality monitoring inside the injection molding machine 1 described above.

In addition, for example, the predetermined signal transmitted from the management device 2 to the injection molding machine 1 may include a safe mode setting signal for setting the boot mode of the FPGA 704A to a “safe mode” in the boot mode setting circuit 706 in FIG. 5 described above. In addition, the predetermined signal transmitted from the management device 2 to the injection molding machine 1 may further include a reset signal for resetting the FPGA 704A in the reset circuit 705 in FIG. 5 described above. In this manner, the management device 2 can automatically reboot the FPGA 704A in the safe mode by the same method as in the second example (FIG. 6) of abnormality monitoring inside the injection molding machine 1 described above.

In addition, for example, the predetermined signal transmitted from the management device 2 to the injection molding machine 1 may include a signal for causing the CPU 701 (system software 7021) in FIG. 7 to set the boot mode of the FPGA 704A to a “safe mode”. In addition, the predetermined signal transmitted from the management device 2 to the injection molding machine 1 may further include a reset signal for resetting the FPGA 704A in the reset circuit 705 in FIG. 7 described above. In this manner, the management device 2 can automatically reboot the FPGA 704A in the safe mode by the same method as in the third example (FIG. 8) of abnormality monitoring inside the injection molding machine 1 described above.

The method of rebooting the injection molding machine 1 from the outside when an abnormality occurs in the injection molding machine 1 may be the same as in the present example in the case of the second example described later.

For example, as described above, the management device 2 may distribute program data for updating a program of the system software 7031 or the application software 7032 installed in the ROM 703A to the injection molding machine 1 through the communication line NW. In this manner, the management device 2 can update various programs installed in the injection molding machine 1 (ROM 703A) through the control device 700.

For example, in a case where processing of installing the distributed update program data in the ROM 703A is performed, the control device 700 may transmit a notification (signal) relating to the execution of the installation processing of the update program data to the management device 2 through the communication line NW. In this manner, the management device 2 can identify that the installation processing of the distributed update program data has been performed.

For example, in a case where an abnormality occurs in the CPU 701 (system software 7021) and the injection molding machine 1 is rebooted within a predetermined period after the installation processing of the update program data is performed, the management device 2 may determine that the update of the program has failed. For example, the predetermined period may be defined in advance by adding a certain margin to the maximum value assumed as the time required from the completion of the installation processing of the update program data in the above procedure (A2) to the completion of the reboot of the CPU 701 (system software 7021) in the procedure (A3). In this case, the management device 2 may perform processing for booting the CPU 701 (system software 7021) in the normal boot mode.

The above predetermined period may be the same as in the present example in the case of the second example described later.

For example, as described above, in a case where it is determined that the cause of the failure of the program update is the failure of the download or the failure of the installation processing, the management device 2 may try to reinstall the update program data. Specifically, the management device 2 may redistribute the update program data to the control device 700 and instruct the reinstallation of the program data for updating the system software 7031 or the application software 7032. In this manner, the management device 2 can shift the injection molding machine 1 (control device 700) that has failed to update the system software 7031 or the application software 7032 to a state where the latest functions can be used at an earlier stage. Therefore, for example, due to the failure to update the system software 7031 of a part of the injection molding machines 1 among the plurality of injection molding machines 1, it is possible to suppress the situation where the deployment of all the latest functions to the injection molding machine 1 is delayed and the production efficiency as a whole is lowered.

In addition, for example, as described above, in a case where it is determined that the cause of the update failure of the program is a defect in the update program data, the management device 2 may try reinstalling to restore to the program data before the update. As described above, this is because the management device 2 can appropriately operate a plurality of injection molding machines 1 even when the injection molding machines 1 (control devices 700) with different versions are mixed in the plurality of injection molding machines 1 (control devices 700), when included in the version matching range. Specifically, the management device 2 may distribute the program data of the old version before the update to the control device 700 and instruct the installation of the program data of the old version of the system software 7031 or the application software 7032. In addition, in a case where the control device 700 is configured to continuously hold the program data of the old version during the installation processing the update program data, the management device 2 may instruct the installation processing of the held program data of the old version to the control device 700. The management device 2 may wait for the completion of the update program data in which the defect has been corrected, and then distribute the update program data (corrected version) to the control device 700.

In addition, for example, as described above, the management device 2 may try reinstalling to restore to the program data before the update, regardless of the cause of the update failure of the program. The management device 2 may redistribute the update program data to the control device 700 after waiting for the update program data to be verified to be free of defects.

The content of the processing for booting the CPU 701 (system software 7021) in the normal function mode may be the same as in the present example in the case of the second example described later.

For example, as described above, the management device 2 may distribute the data for updating the config data 7035 installed in the ROM 703A (update config data) to the injection molding machine 1 through the communication line NW. In this manner, the management device 2 can update the config data 7035 of the FPGA 704A installed in the injection molding machine 1 (ROM 703A) through the control device 700.

For example, in a case where processing of installing the distributed update config data in the ROM 703A is performed, the control device 700 may transmit a notification (signal) relating to the execution of the installation processing of the update config data to the management device 2 through the communication line NW. In this manner, the management device 2 can identify that the installation processing of the distributed update config data has been performed.

For example, in a case where an abnormality occurs in the FPGA 704A and the injection molding machine 1 is rebooted within a predetermined period after the installation processing of the update config data is performed, the management device 2 may determine that the update of the config data 7035 has failed. For example, the predetermined period may be defined in advance by adding a certain margin to the maximum value assumed as the time required from the completion of the installation processing of the update config data in the above procedure (B2) to the completion of the reboot of the FPGA 704A in the procedure (B3). In this case, the management device 2 may perform processing for booting the FPGA 704A in the normal boot mode.

The above predetermined period may be the same as in the present example in the case of the second example described later.

For example, in a case where it is determined that the cause of the update failure of the config data 7035 is a download failure or an installation processing failure, the management device 2 may try to reinstall the update config data. This is because it is not a defect in the update config data itself. Specifically, the management device 2 may redistribute the update config data to the control device 700 and instruct the reinstallation of the config data for updating the config data 7035. In this manner, the control device 700 (CPU 701) can reinstall the update config data and update the config data 7035 under the control of the system software 7021. Therefore, the management device 2 can shift the injection molding machine 1 (control device 700) that has failed to update the config data 7035 to a state where the latest functions can be used at an earlier stage. Therefore, for example, due to the failure to update the config data 7035 of a part of the injection molding machines 1 among the plurality of injection molding machines 1, it is possible to suppress the situation where the deployment of all the latest functions to the injection molding machine 1 is delayed and the production efficiency as a whole is lowered.

In addition, for example, as described above, in a case where it is determined that the cause of the update failure of the config data 7035 is a defect in the update config data, the management device 2 may try reinstalling to restore to the config data before the update. As described above, this is because the management device 2 can appropriately operate a plurality of injection molding machines 1 even when the injection molding machines 1 (control devices 700) with different versions are mixed in the plurality of injection molding machines 1 (control devices 700), when included in the version matching range. Specifically, the management device 2 may distribute the config data of the old version before the update to the control device 700 and instruct the installation of the config data of the old version. In addition, in a case where the control device 700 is configured to continuously hold the config data of the old version during the installation processing of the update config data, the management device 2 may instruct the installation processing of the held config data of the old version to the control device 700. The management device 2 may wait for the completion of the update config data in which the defect has been corrected, and then distribute the update config data (corrected version) to the control device 700.

In addition, for example, as described above, the management device 2 may try reinstalling to restore to the config data before the update, regardless of the cause of the update failure of the config data 7035. The management device 2 may redistribute the update config data to the control device 700 after waiting for the update config data to be verified to be free of defects.

The content of the processing for booting the FPGA 704A in the normal function mode may be the same as in the present example in the case of the second example described later.

As described above, in the present example, the management device 2 is provided outside the injection molding machine 1 and monitors the abnormality in the injection molding machine 1. In a case where an abnormality occurs in the injection molding machine 1, the management device 2 automatically reboots the injection molding machine 1 in a safe mode having a more limited function than the normal boot mode.

In this manner, the management device 2 can monitor the abnormality in the injection molding machine 1 from the outside of the injection molding machine 1 and automatically restore the injection molding machine 1 in a case where the abnormality occurs in the injection molding machine 1. In addition, even in a case where what type of abnormality occurs in the injection molding machine 1, the management device 2 can automatically reboot the injection molding machine 1 in the safe mode in which the functions are limited to the minimum. Therefore, in a case where an abnormality occurs in the injection molding machine 1, the management device 2 can more appropriately automatically restore the injection molding machine 1 in a form capable of dealing with various abnormalities that may occur in the injection molding machine 1.

In addition, in the present example, the management device 2 may be configured so that the data inside the injection molding machine 1 can be updated.

In this manner, for example, the management device 2 can update the data after an abnormality has occurred and rebooted in the safe mode, and can eliminate the cause of the abnormal state in the normal boot mode.

In addition, in the present example, in a case where an abnormality occurs in the injection molding machine 1 after updating the data and the injection molding machine 1 is automatically rebooted in the safe mode, the management device 2 may perform processing for booting the injection molding machine 1 in the normal boot mode.

In this manner, the management device 2 can automatically restore the injection molding machine 1 so that the injection molding machine 1 can be booted in the normal boot mode.

In addition, in the present example, the management device 2 may monitor each abnormality in the plurality of injection molding machines 1.

In this manner, it is possible to suppress the complexity of the configuration of the management system SYS and the increase in cost as compared with the case where the monitoring function is disposed for each injection molding machine 1.

In addition, in the present example, the plurality of injection molding machines 1 include two or more injection molding machines 1 having different versions from each other.

In this manner, the management device 2 can continue to monitor the entire plurality of injection molding machines 1 even in a situation where the injection molding machines 1 with different versions are mixed in the plurality of injection molding machines 1. Therefore, the management device 2 can continue the operation such as monitoring even in a situation where a part of the injection molding machines 1 are not successfully updated and the injection molding machines 1 with different versions are unintentionally mixed.

### Second Example of Abnormality Monitoring Outside Injection Molding Machine

Next, a second example of abnormality monitoring relating to the injection molding machine 1 outside the injection molding machine 1 will be described.

In the present example, the master machine (monitoring device, an example of another injection molding machine) among the plurality of injection molding machines 1 included in the management system SYS may monitor the abnormality in each slave machine under the control of the own machine. In a case where an abnormality occurs in the slave machine, the master machine may transmit a predetermined signal to the target slave machine through the communication line NW, and automatically reboot the slave machine in a safe mode in which a function of the slave machine is restricted more than in the normal boot mode.

In this manner, the master machine can monitor the abnormality in the slave machine from the outside and automatically restore the slave machine in a case where the abnormality occurs in the slave machine.

In addition, in a case where a plurality of master machines exist in the management system SYS, the master machines may mutually perform abnormality monitoring. In a case where an abnormality occurs in the other master machine, one master machine may transmit a predetermined signal to the other master machine through the communication line NW, and automatically reboot the other master machine in a safe mode in which a function of the master machine is restricted more than in the normal boot mode.

In this manner, one master machine can monitor the abnormality in the other master machine, and automatically restore the other master machine in a case where an abnormality occurs in the other master machine. Therefore, it is possible to simplify the configuration of the management system SYS and reduce the cost while dealing with both abnormalities.

In addition, a specific slave machine (monitoring device, an example of another injection molding machine) may perform abnormality monitoring of the corresponding master machine. In a case where an abnormality occurs in the master machine, the specific slave machine may transmit a predetermined signal to the target master machine through the communication line NW, and automatically reboot the master machine in a safe mode in which the function of the master machine is restricted more than in the normal boot mode.

In this manner, the slave machine can monitor the abnormality in the master machine from the outside, and automatically restore the master machine in a case where the abnormality occurs in the master machine. In addition, abnormality monitoring can be mutually performed between the master machine and the slave machine. Therefore, it is possible to simplify the configuration of the management system SYS and reduce the cost while dealing with both abnormalities.

For example, the master machine may distribute program data for updating a program of the system software 7031 or the application software 7032 installed in ROM 703A to the slave machine through the communication line NW. In this manner, the master machine can update various programs installed in the slave machine (ROM 703A) through the control device 700.

For example, in a case where processing of installing the distributed update program data in the ROM 703A is performed, the control device 700 may transmit a notification (signal) relating to the execution of the installation processing of the update program data to the master machine through the communication line NW. In this manner, the master machine can identify that the installation processing of the distributed update program data has been performed on the slave machine.

For example, in a case where an abnormality occurs in the CPU 701 (system software 7021) and the slave machine is rebooted within a predetermined period after the installation processing of the update program data in the slave machine is performed, the master machine may determine that the update of the program has failed. In this case, the master machine may perform processing for booting the CPU 701 (system software 7021) of the slave machine in the normal boot mode.

In this manner, the master machine can automatically restore the CPU 701 so that the CPU 701 (system software 7021) of the slave machine can be booted in the normal boot mode.

In addition, for example, as described above, the master machine may distribute the data for updating the config data 7035 installed in the ROM 703A (update config data) to the slave machine through the communication line NW. In this manner, the master machine can update the config data 7035 of the FPGA 704A installed in the slave machine (ROM 703A) through the control device 700.

For example, in a case where processing of installing the distributed update config data in the ROM 703A is performed, the control device 700 may transmit a notification (signal) relating to the execution of the installation processing of the update config data to the master machine through the communication line NW. In this manner, the master machine can identify that the installation processing of the distributed update config data has been performed on the slave machine.

For example, in a case where an abnormality occurs in the FPGA 704A and the slave machine is rebooted within a predetermined period after the installation processing of the update config data in the slave machine is performed, the master machine may determine that the update of the config data 7035 has failed. In this case, the management device 2 may perform processing for booting the FPGA 704A in the normal boot mode.

As described above, in the present example, the master machine performs the same function as that of the management device 2 of the first example described above with the slave machine as the monitoring target, and has the same action and effect as in the case of the first example described above.

### Modifications and Changes

Hereinbefore, although the embodiments have been described in detail, the present disclosure is not limited to such specific embodiments, and various modifications and changes can be made within the scope of the concept described in the aspects.

For example, in the above-described embodiment, the method of monitoring an abnormality, the method of automatically restoring from an abnormality, and the like have been described for the injection molding machine 1, the same method may be applied to any machine (for example, other industrial machines) or device (for example, home appliances, and the like). Other industrial machines include stationary machines installed in factories, such as machine tools and production robots. In addition, other industrial machines include, for example, mobile work machines. Mobile work machines include, for example, construction machines such as excavators and bulldozers, agricultural machines such as combines, and transport machines such as mobile cranes.

Finally, the present application claims priority based on Japanese Patent Application No. 2020-036151 filed on Mar. 3, 2020, and the entire contents of the Japanese patent application are incorporated herein by reference.

It should be understood that the invention is not limited to the above-described embodiment, but may be modified into various forms on the basis of the spirit of the invention. Additionally, the modifications are included in the scope of the invention.

What is claimed is:

1. An injection molding machine comprising:
an information processing unit; and
a monitoring unit provided separately from the information processing unit and that monitors an abnormality in the information processing unit, wherein
in a case where an abnormality occurs in the information processing unit, the monitoring unit automatically reboots the information processing unit in a predetermined boot mode having a more limited function than a normal boot mode.

2. The injection molding machine according to claim 1, wherein
in a case where the information processing unit is rebooted in the predetermined boot mode by the monitoring unit, the information processing unit notifies a host information processing unit that the information processing unit is rebooted in the predetermined boot mode.

3. The injection molding machine according to claim 2, wherein
the host information processing unit is configured to update data relating to processing of the information processing unit.

4. The injection molding machine according to claim 3, further comprising:
the host information processing unit, wherein
in a case of being notified that the information processing unit is rebooted in the predetermined boot mode from the information processing unit after updating the data, the host information processing unit performs processing for booting the information processing unit in the normal boot mode.

5. The injection molding machine according to claim 1, wherein
the information processing unit periodically outputs a predetermined signal to the monitoring unit during operation, and
the monitoring unit determines presence or absence of an abnormality in the information processing unit depending on presence or absence of reception of the predetermined signal.

6. The injection molding machine according to claim 1, wherein
the information processing unit includes a CPU,
the monitoring unit includes an FPGA, and
in a case where an abnormality occurs in a system software executed on the CPU or a predetermined application software, the FPGA reboots the system software on the CPU using a second program of the system software having a more limited function than a first program of the system software corresponding to the normal boot mode.

7. The injection molding machine according to claim 1, wherein
the information processing unit includes an FPGA,
the monitoring unit includes a CPU, and
the CPU monitors an abnormality in the FPGA by using a predetermined monitoring software, and in a case where the abnormality occurs in the FPGA, the CPU reboots the FPGA using second configuration data corresponding to the predetermined boot mode, which is different from first configuration data corresponding to the normal boot mode.

8. The injection molding machine according to claim 7, wherein
in a case where the FPGA is booted in the normal boot mode, the FPGA receives the first configuration data from an outside under a control of a predetermined boot software executed on the CPU, and in a case where the FPGA is booted in the predetermined boot mode, the FPGA receives the second configuration data from the outside under a control of a predetermined circuit unit provided inside the FPGA, and
in a case where the abnormality occurs in the FPGA, the CPU outputs a notification to the FPGA so that the FPGA boots in the predetermined boot mode, and resets the FPGA.

9. The injection molding machine according to claim 7, wherein
in a case where the FPGA is booted in the normal boot mode, the FPGA receives the first configuration data from an outside under a control of a predetermined boot software executed on the CPU, and in a case where the FPGA is booted in the predetermined boot mode, the FPGA receives the second configuration data from the outside under the control of the boot software, and
in a case where the abnormality occurs in the FPGA, the CPU resets the FPGA and transmits the second configuration data to the FPGA from the outside using the boot software.

10. The injection molding machine according to claim 1, wherein
a plurality of the information processing units are provided,
the plurality of information processing units include a first information processing unit and a second information processing unit, and
the first information processing unit and the second information processing unit mutually monitor an abnormality in the other as the monitoring unit, and in a case where an abnormality occurs in the other, reboot the other in the predetermined boot mode.

11. An injection molding machine system comprising:
an injection molding machine; and
a monitoring device provided outside the injection molding machine and that monitors an abnormality in the injection molding machine, wherein
in a case where an abnormality occurs in the injection molding machine, the monitoring device automatically reboots the injection molding machine in a predetermined boot mode having a more limited function than a normal boot mode.

12. The injection molding machine system according to claim 11, wherein
the monitoring device is configured to update data inside the injection molding machine.

13. The injection molding machine system according to claim 12, wherein
in a case where the abnormality occurs in the injection molding machine after updating the data and the injection molding machine is automatically rebooted in the predetermined mode, the monitoring device performs processing for booting the injection molding machine in the normal boot mode.

14. The injection molding machine system according to claim 11, wherein
a plurality of the injection molding machines are provided, and
the monitoring device monitors each abnormality in the plurality of injection molding machines.

15. The injection molding machine system according to claim 14, wherein
the plurality of injection molding machines include two or more injection molding machines having different versions from each other.

16. The injection molding machine system according to claim 11, wherein
the monitoring device is another injection molding machine.

17. A monitoring device that is communicably connected to an injection molding machine and automatically reboots the injection molding machine in a predetermined boot mode having a more limited function than a normal boot mode in a case where an abnormality occurs in the injection molding machine.
